(19) United States
(12) Patent Application Publication
(10) Pub. No.: US 2026/0203339 A1
(43) Pub. Date: Jul. 16, 2026

(54) SPECIALIZED SUB-TASK MODELS USED TO PERFORM A TARGET TASK

(71) Applicant: Microsoft Technology Licensing, LLC, Redmond, WA (US)

(72) Inventors: Zhoutong Fu, Milpitas, CA (US); Yiyuan Tu, Milpitas, CA (US); Haichao Wei, Santa Clara, CA (US); Yi-Lin Chen, San Jose, CA (US); Neha Saraf, Sunnyvale, CA (US); Liming Dong, Mountain View, CA (US); Andrew Stephen Wu, Berkeley, CA (US); Yihan Cao, Mountain View, CA (US); Aman Lunia, New York, NY (US)

(21) Appl. No.: 19/018,329

(22) Filed: Jan. 13, 2025

(51) Int. Cl. G06F 16/353; G06F 16/338

(52) U.S. Cl. CPC G06F 16/353; G06F 16/3344; G06F 16/338; G06F 16/90332

(57) ABSTRACT

Embodiments of the disclosed technologies are capable of deploying a sequence of sub-task models to perform a target task. A query is received that includes a digital content item with a criterion. A task responsive to the query is determined. A first sub-task and second sub-task are generated from the task. The first sub-task includes a classification task related to a user and the criterion. The second sub-task includes a content generation task related to the classification task. The first sub-task is performed by determining a classification for the user with respect to the criterion. The second sub-task is performed by determining a natural text explanation for the classification. The classification and the natural language text explanation are presented via a user interface.

### TECHNICAL FIELD

Embodiments of the invention relate to the technical field of sub-task models used to perform a target task.

### BACKGROUND

Artificial Intelligence (AI) is the implementation of artificial neural network systems that aim to mimic the functionality of neurons in the brain. Machine learning is a sub-area of AI in which a machine learning model is trained to perform one or more specific tasks. For instance, a machine learning model can be trained to perform a target task by relying on patterns and inferences learned from training data, without requiring explicit instructions pertaining to how the task is to be performed.

### BRIEF DESCRIPTION OF THE DRAWINGS

The invention may best be understood by referring to the following description and accompanying drawings that are used to illustrate embodiments of the invention. In the drawings:

FIG. 1 is a flow diagram of an example method for training sub-task models using a training manager of a computing system, in accordance with some embodiments of the present disclosure.

FIG. 2 is an example flow diagram for training the classifier sub-task model for a classification sub-task using a student-teacher framework, in accordance with some embodiments of the present disclosure.

FIG. 3 is an example flow diagram for training the explanation sub-task model for a content generation sub-task using a student-teacher framework, in accordance with some embodiments of the present disclosure.

FIG. 4 is a flow diagram of an example method for deploying a sequence of sub-task models during inference, in accordance with some embodiments of the present disclosure.

FIGS. 5A-5B illustrate an example user interface associated with deploying a sequence of sub-task models to perform a target task, in accordance with some embodiments of the present disclosure.

FIG. 6 is a block diagram of a computing system that includes sequence of sub-task models, in accordance with some embodiments of the present disclosure.

FIG. 7 is a flow diagram of an example method for deploying a sequence of sub-task models to perform a target task, in accordance with some embodiments of the present disclosure.

FIG. 8 is a block diagram of an example computer system including a training manager and a sequence of sub-task models, in accordance with some embodiments of the present disclosure.

FIG. 9 is a block diagram of a machine learning model that can be used by and/or included in a generative model, in accordance with some embodiments of the present disclosure.

### DETAILED DESCRIPTION

There are many different types of machine learning models that can be used to perform a target task. For example, generative models use artificial intelligence technology, e.g., neural networks, to machine-generate new digital content based on model inputs and the previously existing data with which the model has been trained. A generative language model is a particular type of generative model that generates new text in response to model input. A large language model (LLM) is a type of generative language model that is trained using an abundance of data (e.g., publicly available data) such that billions of hyperparameters that define the LLM are used to iteratively develop statistical correlations that enable the performance of a target task such as summarizing existing content, generating new content, using reasoning to evaluate content, and the like.

Generative language models are trained to perform a target task by relying on patterns and inferences learned from training data, without requiring explicit instructions to perform the target task. For example, generative language models iteratively predict tokens to generate a string of tokens (e.g., natural language text). In operation, generative language models track relationships in sequential data by receiving tokens (e.g., words in a sentence) and predicting a next token (or sequence of tokens). As such, generative language models are able to mimic human language by generating responses that are coherent and contextualized.

The input to a generative language model (both a training input or an input used during deployment of the generative language model) includes a task description, also referred to as a prompt. A prompt can be in the form of natural language text, such as a question or a statement, and can include non-text forms of content, such as digital imagery and/or digital audio. The prompt can include instructions and/or examples of content used to explain the task that the generative language model is to perform. Modifying the instructions, examples, content, and/or structure of the prompt causes modifications to the output of the generative language model. For example, changing the instructions included in the prompt causes changes to the generated content determined by the generative language model.

Crafting the prompts used by the generative model can be technically challenging. For example, determining what information to include in prompt and how to convey the information in the prompt is directly related to how the generative language model performs its target task. Prompt engineering is a technique used to optimize the structure and/or content of the prompt.

Some prompts can include examples of outputs to be generated by the generative language model (e.g., few-shot prompts), while other prompts can include no examples of outputs to be generated by the generative language model (e.g., zero-shot prompts). Chain of thought reasoning is a prompt engineering technique where the prompt includes a request that the generative language model explain reasoning in the output. For example, the generative language model performs the task provided in the prompt using intermediate steps where the generative model explains the reasoning as to why it is performing each step.

Given the ability of generative language models to generate natural language text (such as summaries or explanations), conventional systems use such generative language models for text generation and tune the prompts of the generative language model to obtain generated text that satisfies criterion (e.g., the length of the natural language text, the content of the natural language text, the phrasing of the natural language text, etc.). For example, a generative language model can be used to perform an evaluation target task. The evaluation target task includes an evaluation and explanation as to whether an object satisfies criteria.

In a non-limiting example, a job fitness evaluation performed by a generative language model (e.g., an evaluation target task) includes generating natural language text to explain to a user whether the user matches criteria identified in a job posting. The performance of such a target task can lead to variable outputs. For example, the generative model can perform the evaluation target task but generate natural language text that is vague (e.g., “the user profile matches some job requirements.”) To tune the granularity and specificity of the generative language model response (e.g., identifying which criteria are satisfied, explaining why criteria is satisfied or unsatisfied given a user's profile information, etc.) conventional systems would need to tune the prompt of the generative language model, which is a technically challenging process. Prompt tuning can be performed manually over a number of iterations, increasing computing resources such as power, memory, and bandwidth associated with iteratively tuning the prompt of the generative language model over the large number of iterations.

Aspects of the present disclosure divide a target task into sub-tasks, where each sub-task is performed using a specialized sub-task model. Each specialized sub-task model can be a smaller machine learning model than the machine learning model used to perform the target task, resulting in the consumption of fewer computing resources. For example, a sequence of specialized sub-task models can perform a target task such as a job fitness evaluation task in about 6 seconds, with a classification sub-task being performed in less than 1 second and an explanation sub-task being performed in about 5 seconds. In contrast, completing the entire target task and/or using out of the box models can take longer. For example, performing the explanation sub-task can take about 20 seconds using an out of the box generative language model. The combination of sub-task models achieves the result of a tuned response without the need to prompt engineer the prompt of a generative model. Breaking the target task into sub-tasks provides structure to a process that is conventionally solved using prompt engineering trial and error over a number of iterations. In other words, each sub-task addresses a deficiency of a response conventionally generated by a generative language model that would conventionally be addressed using prompt engineering trial and error.

Pretrained machine learning models such as out of the box or open-source machine learning models generally have large architectures and are pretrained with publicly available data (e.g., domain-neutral data). Pretrained machine learning models are trained over a number of iterations such that the pretrained machine learning models iteratively develop statistical correlations used to perform a diverse range of tasks. However, given the size of such models, there may be delays associated with performing any task of the diverse range of task. This delay can be exacerbated given a large number of queries per second. In other words, the higher the number of users calling the machine learning model, the higher the number of queries per second are, resulting in increased delays in responding to the high volume of queries. In addition to increased delays, significant computing resources are consumed to respond to such high volumes of query given the large architecture of pretrained machine learning models. As a result, pretrained machine learning models are not scalable in environments where many users call the machine learning model to respond to a query such as “am I a good fit for this job” simultaneously or near simultaneously.

In addition, pretrained machine learning models can be well suited to perform various domain-neutral tasks (e.g., tasks learned using widely available or public data), but applying domain-specific data to such machine learning models can cause a drop of the machine learning model's performance. For example, a machine learning model is less suited to perform text summarization of a domain-specific text if the machine learning model has not been trained to summarize text using domain-specific language.

In contrast, specialized machine learning models have architectures smaller than the large architectures of pretrained machine learning models (e.g., have fewer parameters than the pretrained machine learning model), by virtue of being are encoded with less pretrained domain-neutral information. The specialized models perform fewer tasks, but the tasks may be specialized (e.g., domain-specific), and the fine-tuned machine learning model may be faster at performing the tasks.

Fine-tuning, as used herein may refer to a mechanism of adjusting the parameters of a specialized machine learning model that has been previously trained (e.g., pretrained), and then tuning the machine learning model to perform tasks using targeted or specialized datasets. As a result of fine-tuning the specialized machine learning model, the specialized machine learning model is capable of performing specialized tasks (e.g., domain-specific tasks) at an accuracy at least the same as, or better than, the accuracy of generalized pretrained machine learning models in performing the same task.

Supervised learning is a method of training (or fine-tuning) a machine learning model, such as a generative language model, given input-output pairs. An input-output pair is an input with an associated known output (e.g., an expected output, a labeled output, a ground truth). During a training period, a machine learning model iteratively develops statistical correlations used to perform a task, such as a natural language processing (NLP) task or a classification task, by receiving training samples included as a training input. The machine learning model then predicts an output, by identifying one or more values with the highest confidence scores or probabilities, related to the task to be learned and compares the predicted output to the known output associated with the training input (e.g., the labeled output of the input-output pair). Over time, (e.g., a number of training iterations), an error based on the difference between the predicted output and the labeled output decreases.

During fine-tuning, the machine learning model receives domain-specific information such as vocabulary. Accordingly, the fine-tuned model is trained with the domain-specific data (e.g., vocabulary) and the accuracy of performing a task in a domain-specific environment increases. However, sometimes there is not enough training data to fine-tune the model. Training or fine-tuning the machine learning model to perform a target task requires large amounts of training samples (including training inputs and associated labeled outputs). Collecting such training samples can be time consuming, costly, and error prone. For example, in some conventional approaches, hundreds of thousands of training samples (e.g., input-output pairs) are used to train the machine learning model. If there is not enough training data, then the machine learning model does not develop the statistical correlations to encode domain-specific information.

Implementations of the described approaches train domain-specific machine learning models to perform respective domain-specific sub-tasks by distilling domain-specific knowledge from a pretrained machine learning model. In other words, domain-specific knowledge is transferred from the generalized pretrained machine learning model to sub-task-specific machine learning models. In this manner, each sub-task-specific machine learning model is fine tuned to perform a specific sub-task while also encoding domain-specific knowledge distilled from the generalized pretrained machine learning model. The sub-task specific machine learning models can perform domain-specific sub-tasks faster than the generalized pretrained machine learning model in part, because of the each of the sub-task specific machine learning model's smaller architecture, allowing the sub-task specific machine learning model to perform sub-tasks with reduced delay as compared to the delay associated with the generalized pretrained machine learning model's performance of a target task.

Implementations of the described approaches use a generalized pretrained machine learning model to generate domain-neutral training data (e.g., seed training data). A domain-specific model uses the seed training data to generate domain-specific training data (e.g., synthetic training data) used in semi-supervised learning to fine-tune a specialized model to perform a sub-task. Because the domain-specific model generates domain-specific training data using the domain-neutral training data, the burden of obtaining domain-specific training data is reduced. For example, resources associated with obtaining domain-specific training data (e.g., human resources associated with manually reviewing and/or annotating training data; financial resources associated with paying humans to manually review training data; computing resources associated with prolonged manual review of training data) are reduced.

The disclosure will be understood more fully from the detailed description given below, which references the accompanying drawings. The detailed description of the drawings is for explanation and understanding and should not be taken to limit the disclosure to the specific embodiments described.

In the drawings and the following description, references may be made to components that have the same name but different reference numbers in different figures. The use of different reference numbers in different figures indicates that the components having the same name can represent the same embodiment or different embodiments of the same component. For example, components with the same name but different reference numbers in different figures can have the same or similar functionality such that a description of one of those components with respect to one drawing can apply to other components with the same name in other drawings, in some embodiments.

Also, in the drawings and the following description, components shown and described in connection with some embodiments can be used with or incorporated into other embodiments. For example, a component illustrated in a certain drawing is not limited to use in connection with the embodiment to which the drawing pertains but can be used with or incorporated into other embodiments, including embodiments shown in other drawings.

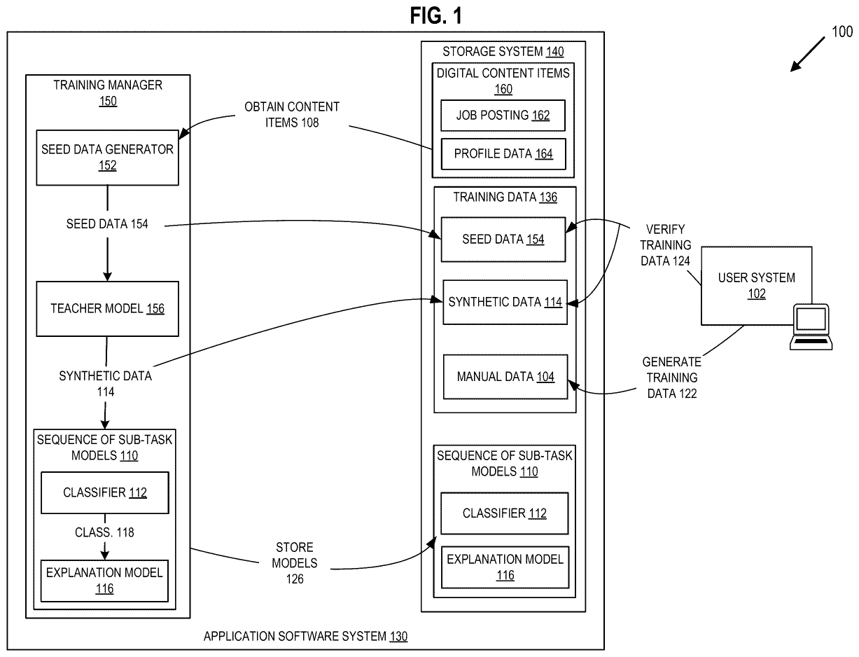

FIG. 1 is a flow diagram of an example method for training sub-task models using a training manager of a computing system, in accordance with some embodiments of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In the example of FIG. 1, computing system 100 includes a user system 102, an application software system 130, a training manager 150, and a storage system 140. The storage system 140 stores data that has been received, used, manipulated, and/or produced by the application software system 130. Data stored by the storage system 140 includes digital content items 160, training data 136, and a sequence of sub-task models 110 such as classifier 112 (e.g., a first sub-task model) and explanation model 116 (a second sub-task model).

Application software system 130 is any type of application software system that provides or enables at least one type of response to a user query to be presented to a user system. Examples of application software system 130 include but are not limited to connections network software, such as social media platforms, and systems that are or are not based on connections network software, such as general-purpose search engines, job search software, recruiter search software, sales assistance software, content distribution software, learning and education software, or any combination of any of the foregoing.

The training manager 150 facilitates training of a sequence of sub-task models 110, as described herein. The training manager 150 includes a seed data generator 152 and a teacher model 156 used to train or otherwise fine-tune sub-task models of a sequence of sub-task models 110 such as classifier 112 and explanation model 116.

User system 102 includes at least one computing device, such as a personal computing device, a server, a mobile computing device, or a smart appliance. User system 102 includes at least one software application, enabling the user system 102 to bidirectionally communicate with the application software system 130. Additionally, the user system 102 can include a user interface that allows a user to generate training data 122 and/or verify training data 124. The training data 136 is an input-output pair of data including labels (e.g., an output of the input-output pair) corresponding to digital content items 160 (e.g., an input of the input-output pair). Digital content items 160 include any digital content provided by the application software system 130 that can be presented to the user using the user system 102 (e.g., using audio and/or natural language text). Digital content items 160 can include user uploaded content. For example, digital content items 160 can job posting 162 and profile data 164.

A job posting 162 is a digital content item with content describing a job associated with an entity. The job posting 162 can include information about the job and the entity associated with the job. Job postings 162 include one or more criteria associated with the job. In some embodiments, the criteria of the job posting 162 is explicitly grouped. For example, the job posting can include “required” criteria with a list of specific degrees, qualifications, or certifications (e.g., “a Bachelor's degree in Electrical Engineering”). An example of a group of “preferred” criteria identified in a job posting 162 can include a number of years of experience in a specific field (e.g., “3+years of marketing experience.”) In some embodiments, the criteria of the job posting 162 is grouped implicitly. For example, the context associated with the criterion can indicate a priority. For instance, a sentence describing the characteristics of “ideal candidates” can be used to generate a group of criteria associated with “required” criteria.

Profile data 164 can include any information associated with a user. For example, when a user interacts with an application of the application software system 130, the user provides personal information, such as a name, age (e.g., birthdate), gender, interests, contact information, home town, address, spouse's and/or family members' names, educational background (e.g., schools, majors, matriculation and/or graduation dates, etc.), employment history, skills, interests, professional, employment history, area of expertise, organizations, and so on. Some or all of such information can be stored as profile data 164. Profile data 164 may also include profile data of various organizations/entities (e.g., companies, schools, etc.).

Training data 136 includes input-output pairs associated with a target task. For example, the target task can be to evaluate a user's fitness. The user's fitness is a metric that represents the degree of matching between the profile data 164 and a job posting 162. A higher degree of matching corresponds to a higher user fitness with respect to the job posting 162. For example, a higher user's fitness represents criteria indicated in the job posting 162 being mapped to user skills or attributes indicated in profile data 164. A lower degree of matching corresponds to a lower user fitness with respect to job posting 162. For example, a lower user's fitness represents criteria indicated in the job posting 162 not being mapped (or partially being mapped) to the user skills or attributes indicated in the profile data 164. The input of the input-output pair of training data 136 includes a group of data such as digital content items 160 (e.g., job postings 162 and profile data 164).

The output of the input-output pair of training data 136 includes a label. The label represents a user associated with profile data 164 fitness with respect to a job posting 162. For example, the label can classify whether the user information indicated in the profile data 164 matched or semantically matched with one or more criterion included in the job posting 162. For example, if profile data 164 indicates that a user has 10 years of experience styling hair in a hair salon, then a label associated with the job posting criterion “3+years of cosmetology experience” can indicate “overqualified.” The output of the input-output pair of the training data 136 also includes an explanation of the label. For example, given the example above with a criterion indicating “3+years of cosmetology experience” and a user having 10 years of working in a hair salon, reasoning for the “overqualified” label can include “the user is overqualified for the job posting because the user has over three times the required experience for this job since cosmetology experience includes experience styling hair in a hair salon.”

When a user of user system 102 generates training data 122, the user creates manual training data 136 such as manual data 104. Manual data 104 is a user of user system 102 generating input-output pairs used to train the sequence of sub-task models 110. In an example, a user labels and subsequently explains the label associated with a job posting 162 and profile data 164. For example, the user of the user system 102 can classify a user (defined according to profile data 164) with respect to whether the skills or attributes of that user match or semantically match with criteria identified in the job posting 162. The user of the user system 102 can subsequently provide reasoning or logic that supports the classification of the user (defined according to the profile data 164).

The user of user system 102 can also verify training data 124. When the user verifies training data 124, the user evaluates the group of training data (e.g., job postings 162, profile data 164, labels, and explanations) determined by the seed data generator 152 and/or the teacher model 156, respectively. In other words, the user of the user system 102 verifies the seed data 154 and/or the synthetic data 114, respectively. In operation, the user reads an input of the training data (e.g., a job posting 162 and profile data 164) and verifies that the corresponding output of the training data (e.g., a label classifying the user's fitness with respect to the job posting, based on attributes or skills of the user that match or semantically match criteria in the job posting, and an explanation for such labels) is accurate. For example, if user information defined by the profile data matches or semantically matches a criterion identified in the job posting, an accurate label could be “match” and an explanation for the label would explain the match of the user information and the job posting criteria.

As described herein, the training manager 150 facilitates training of the sub-task models of the sequence of sub-task models 110 using a seed data generator 152 and a teacher model 156. Sub-tasks are tasks decomposed from a target task. Each sub-task performed by a sub-task model addresses a deficiency of the output associated with the target task. For example, as described herein, an example target task is an evaluation target task, in which a model responds to a user's query “am I a good fit for this job.” An example response generated by a model performing the target task can include one or more deficiencies such as generating a vague response. For example, a conventional system's evaluation of a user's fitness with respect to the criteria of a job posting 162 can include “your profile matches some job requirements.” To obtain a more granular response, various sub-task machine learning models are trained to perform sub-tasks in furtherance of a more granular and structured response, where the response is the performance of the target task.

Decomposing a target task (e.g., an evaluation task) into sub-tasks injects structure into the performance of the target task. For example, instead of a conventional system's evaluating the totality of the job posting with respect to the user, a sequence of sub-task models 110 each perform a sub-task associated with the target task. Each sub-task model of the sequence of sub-task models 110 is configured to perform a task indirectly or directly associated with the target task. The sub-task models in the sequence of sub-task models 110 use the output from one sub-task model as an input to a subsequent sub-task model to provide structure for the subsequent sub-task model. In this manner, instead of performing a target task in its entirety (e.g., like conventional systems), each sub-task model performs a sub-task that guides the performance of a next sub-task in the sequence of sub-tasks. For example, a classification sub-task, performed by classifier 112, performs a classification of the user's fitness with respect to one or more criterion identified in the job posting. An explanatory task, performed by the explanation model 116, generates explanatory content associated with the classifications identified by the classifier 112. As a result, the response to the user query “am I a good fit for this job,” performed by a sequence of sub-task models 110 each performing a sub-task decomposed from the target task, is a structured response that identifies a classification of the user's fitness with respect to one or more criterion in the job posting and explanatory content associated with the classification of the user's fitness. That is, one or more classifications determined by the classifier 112 are used to guide the natural language content generated by the explanation model 116, providing structure that would otherwise not be present without the classifier 112.

As described herein, a target task includes evaluating a user's fitness. However, it should be appreciated that the training manager 150 can train a sequence of sub-task models 110 associated with the performance of other target tasks. In other words, each sequence of sub-task models 110 stored in the storage system 140 can be called to perform a particular target task.

In a non-limiting example, the target task can be a recommendation task such as recommending a candidate user to a query user. The sequence of sub-task models associated with the recommendation task could be a first sub-task model configured to cluster similar profile data of the candidate user with similar profile data of the query user, creating clusters of similar attributes (e.g., clusters of similar entities such as schools or companies, clusters of similar third-party users such as friends in common between the candidate user and the query user). Clusters of similar profile data can also include shared interests based on similar interactions with digital content items (e.g., similar shared digital content items, similar liked digital content items, similar reposted digital content items, etc.). A second sub-task model of the sequence of sub-task model could be configured to generate explanatory content based on clusters of similar profile data. For example, explanatory content can include an explanation of why a candidate user is recommended to a query user based on the clusters of similar profile data. A third sub-task model of the sequence of sub-task models could be configured to rank candidate users with respect to the query user according to the explanatory content. The ranked candidate users can be presented to the query user as recommended users to interact with. For example, the query user can send messages to the recommended users and/or save profiles of the recommended users.

As described herein, the target task is a task with respect to a single user such as a query user (e.g., evaluating the query user's fitness with respect to a job posting). However, it should be appreciated that the target task can be associated with a group of users. In some embodiments, each sequence of sub-task models 110 is executed in parallel for each user in the group of users. As a result, the sequence of sub-task models 110 is executed a number of times equal to the number of users in the group of users. In some embodiments, the sequence of sub-task models 110 is executed once for the group of users.

The seed data generator 152 can be any machine learning model configured to generate training data 136 (e.g., seed data 154). For example, the seed data generator 152 can be a domain-neutral or out of the box machine learning model. Because the seed data generator 152 is domain-neutral, the seed data 154 is domain-neutral.

In some embodiments, the seed data generator 152 is a generative pretrained transformer (GPT) machine learning model. In some embodiments, the seed data generator 152 can be any sequence-to-sequence machine learning model. For example, the seed data generator 152 can include an instance of a text-based encoder-decoder model that accepts a string as an input and outputs a string. The seed data generator 152 is trained on domain-neutral data (e.g., publicly available data) to perform one or more domain-neutral tasks. The seed data generator 152 can be pretrained using any training method such as supervised learning, unsupervised learning, semi-supervised learning, reinforcement learning, etc.

In operation, the seed data generator 152 obtains content items 108 (e.g., a job posting 162 and profile data 164). The obtained content items 108 correspond to the group of data used as an input of the input-output pair of training data 136. The seed data 154 generated by the seed data generator 152 corresponds to the output of the input-output pair of the training data 136. In some embodiments, the seed data generator 152 generates the input of the input-output pair of training data 136 such that the seed data 154 includes a generated job posting and/or profile data. In some embodiments, the seed data generator 152 receives manual data 104. For example, the manual data 104 can be received as an example of a classification and explanatory response of a prompt used by the seed data generator 152.

The seed data 154 generated by the seed data generator 152 can include a one-pass approach to the sub-tasks. For example, if a first sub-task is a classification task and a second sub-task is an explanation task, the seed data generator 152 generates seed data 154 that both classifies and generates an explanatory response in a single pass. In some embodiments, the seed data generator 152 is executed a number of times equal to a number of sub-tasks. For example, the seed data generator 152 is executed a first time to generate classification seed data 154, and the seed data generator 152 is executed a second time to generate explanatory seed data 154. The type of seed data 154 generated by the seed data generator 152 is dependent on the instructions provided to the seed data generator 152 (e.g., a prompt provided to the seed data generator 152). For example, the granularity of the seed data 154 (e.g., the length of the explanatory response, the content of the explanatory response, the phrasing of the response, etc.) is adjusted depending on the prompt and tuned using any one or more prompt engineering techniques such as chain of thought prompting. The seed data 154 is stored as training data 136 in the storage system 140.

The teacher model 156 can be any domain-specific machine learning model configured to generate training data 136 (e.g., synthetic data 114). The purpose of the teacher model 156 is to increase the volume of training data 136 by generating synthetic data 114. Additionally, because the teacher model 156 is domain-specific, the synthetic data 114 generated by the teacher model 156 is domain-specific. For example, whereas the seed data generator 152 is capable of generating seed data 154 associated with “work experience” generally, the teacher model 156 is capable of generated synthetic data 114 associated with “marketing work experience” or some other domain-specific work experience. In operation, the teacher model 156 receives the seed data 154 generated by the seed data generator 152 and generates synthetic data 114, which is more voluminous than the seed data 154, by virtue at least in part of the inclusion of domain-specific information.

Similar to the operation of the seed data generator 152, the teacher model 156 can generate synthetic data 114 using a one-pass approach to the sub-tasks. For example, if the first sub-task is a classification sub-task and the second sub-task is an explanation sub-task, the teacher model 156 generates synthetic data 114 that both classifies and generates explanatory responses in a single pass. In some embodiments, the teacher model 156 is executed a number of times equal to the number of sub-tasks. For example, the teacher model 156 is executed a first time to generate classification synthetic data 114, and the teacher model 156 is executed a second time to generate explanatory synthetic data 114.

In operation, the teacher model 156 receives the seed data 154 including digital content items 160 that correspond to the group of inputs of the input-output pair of training data 136 (e.g., the job posting 162 and profile data 164). The synthetic data 114 generated by the teacher model 156 corresponds to the output of the input-output pair of the training data 136 (e.g., classifications and/or explanatory responses). The synthetic data 114 is stored as training data 136 in the storage system 140. In some embodiments, the teacher model 156 receives manual data 104. For example, the manual data 104 can be received as an example of a classification and explanatory response of a prompt used by the teacher model 156.

Training data 136 is generated in a scalable manner using the seed data generator 152 and the teacher model 156. In operation, a small set of job postings 162 and profile data 164 can be used as a foundation for machine generated training data 136 such as seed data 154 and synthetic data 114. In some embodiments, before digital content items 160 are used to generate training data 136, user permission is obtained. For example, an author of a digital content item 160 consents to using digital content item 160 as training data 136.

As described herein, manually generating training data 136 (e.g., manual data 104) is costly, time-consuming, and error prone. Accordingly, the amount of manual data 104 used by the training manager 150 to train the sequence of sub-task models 110 is limited. The seed data generator 152 and teacher model 156 expand or otherwise supplement the limited set of training data (e.g., manual data 104) used for training the sub-task models by generating seed data input-output pairs, seed data outputs (e.g., classifications and explanatory content), synthetic data input-output pairs, synthetic data outputs, or some combination. The generated training data is passed to the storage system 140 for storage as seed data 154 and synthetic data 114 (e.g., part of training data 136).

As described herein, the sequence of sub-task models 110 include sub-task models that each perform a sub-task decomposed from the target task. The sequence of sub-task models 110 act as guides to generate an output that is structured and granular, as compared to the output of other conventional system's performance of a target task. The sequence of sub-task models 110 are each curated to address the deficiencies of a pretrained model such as seed data generator 152 and/or teacher model 156.

The sequence of sub-task models 110 associated with performing an evaluation target task include a classifier 112 and explanation model 116. In operation, the classifier 112 performs a classification sub-task and the explanation model performs a content generation sub-task, where both classification and content generation are sub-tasks divided from the target (e.g., evaluating a fitness of a user).

The classifier 112 and explanation model 116 are smaller than the teacher model 156 and the seed data generator 152 model. For example, the architectures of the classifier 112 and/or explanation model 116 are smaller than the teacher model 156 and the seed data generator 152 such that the number of weights, nodes, and other hyperparameters of the classifier 112 and explanation model 116 are fewer than the number of weights, nodes, and/or hyperparameters of the teacher model 156 and the seed data generator 152.

The classifier 112 sub-task model guides the second sub-task model (e.g., the explanation model 116) to explain a classification of the criteria of the digital content item. In operation, the classifier 112 classifies a user's fitness with respect to one or more criterion of the digital content item. Examples of criteria identified in a digital content item can include “18 years or older,” “Bachelor's degree in Marketing or a related field,” “start-up experience,” and “3+years of experience in marketing roles.” In some embodiments, multiple classifiers 112 are configured to classify different types of criteria.

The classifier 112 can be an embedding based classifier that performs multiclass classification (e.g., “no fit,” “overqualified,” “potential fit,” “good fit,” or “great fit” classes) or binary classification (e.g., “no fit” or “fit” classes). Such classifiers receive an input (e.g., the synthetic data 114 including a job posting and profile data) and determine an output classification by identifying a probability or confidence of each class in a in a set of candidate classes (e.g., “no fit,” “overqualified,” “potential fit,” “good fit,” or “great fit” classes). The probability associated with the highest class is selected as classification 118 of the input (e.g., the user's fitness according to the profile data with respect to one or more criterion of the job posting). In some embodiments, embedding based classifiers are neural networks such as multi-layer perceptrons.

The classifier 112 can also be causal language classifiers. Such classifiers receive an input and generate tokens corresponding to a class. For example, the classifier 112 can generate a “n” token corresponding to the “no fit” class, an “o” token corresponding to the “overqualified class” and the like. In some implementations, the classifier 112 generates constrained text. For example, the classifier 112 generates strings of tokens corresponding to “no fit” or “fit” classes. In some embodiments, causal language classifiers are neural networks such as transformers.

The classifier 112 can be optimized using any one or more optimization techniques. For example, nodes and/or weights of the architecture of the classifier 112 can be pruned using any one or more pruning techniques. Additionally or alternatively, the attention mechanism of transformers can be optimized using linear attention optimizations, where the SoftMax function used to perform attention is replaced with linear attention methods.

The classifier 112 passes the classification 118 along with the job posting and profile data, to the explanation model 116. The explanation model 116 is any one or more generative models configured to perform a content generation sub-task by generating content that is understandable to a user. The generated content conveys the classification of the user's fitness with respect to the job posting (e.g., a criterion identified in the job posting, a group of criteria identified in the job posting, the user's fitness with respect to the job posting in its entirety, or the like). For example, the generated content can include a natural language description of why or how the classification relates to or otherwise addresses the criteria of the job posting and the profile data.

In some embodiments, a sub-task model (e.g., the explanation model 116 and/or the classifier 112) can aggregate or group classifications of criterion to determine a total classification of the user with respect to the job posting. In some embodiments, the total classification is based on thresholding. For example, a sub-task model can compare the number of classifications determined by the classifier 112 to one or more total classification thresholds. For example, if the number of positive classifications (e.g., “fit” or “match” or “overqualified”) satisfy a totally classification threshold, then the total classification of the user with respect to the job posting is a positive classification (e.g., “fit” or “match”).

In some embodiments, the total classification is determined using the explanation model 116 and the one or more classifications determined by the classifier 112. For example, the explanation model is instructed to generate a total classification of the user with respect the job posting based on the classifications 118 received from the classifier 112. The explanation model 116 subsequently generates content providing reasoning and support for the total classification. In a non-limiting example, classifications 118 received from the classifier 112 can include a “match” for the user with respect to five of the eight criteria identified in a job posting 162. The explanation model 116 can generate a total classification of “majority match” with respect to the user and the job posting 162 based on the received classifications 118. The explanatory content associated with the total classification “majority match” can be natural language text that explains “you are a good match for this job because your experience and skills satisfy the majority of the criteria identified in this job posting.”

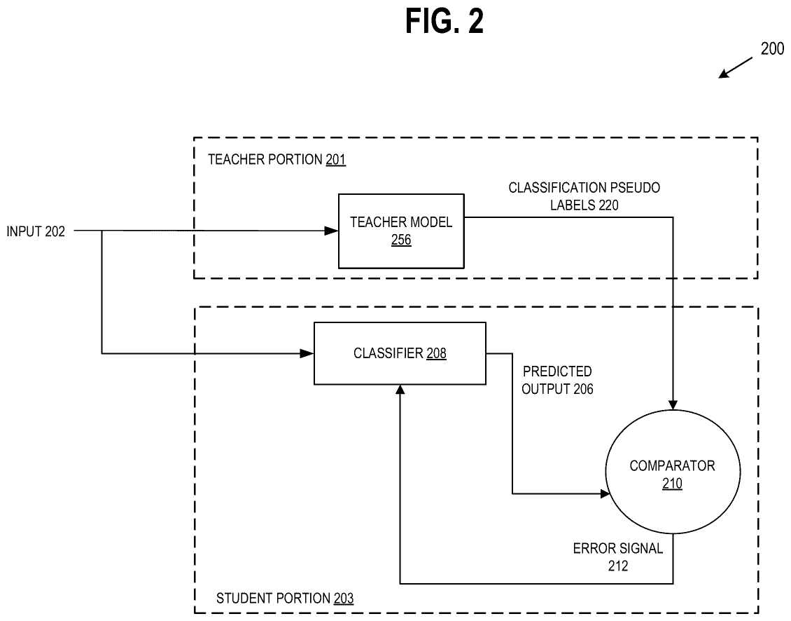

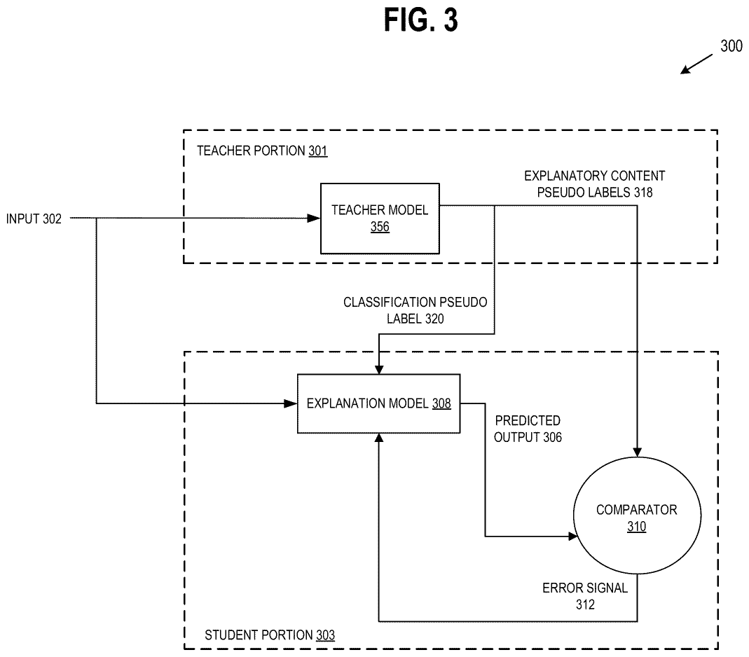

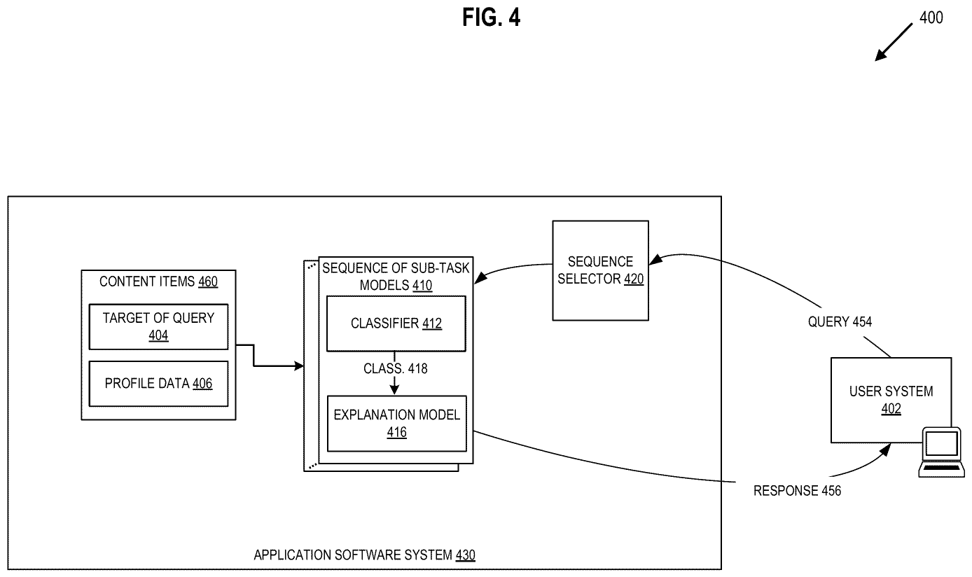

The training manager 150 trains the sequence of sub-task models 110 to perform each model's respective sub-tasks for a number of training iterations during a training period. Training example sub-task models of the sequence of sub-task models 110 is further described in FIGS. 2-3 described herein. After training, the sequence of sub-task models 110 are stored 126 in the storage system for use during deployment, described in FIG. 4.

The examples shown in FIG. 1 and the accompanying description above are provided for illustration purposes. This disclosure is not limited to the described examples. Additional or alternative details and implementations are described herein.

FIG. 2 is an example flow diagram for training the classifier sub-task model for a classification sub-task using a student-teacher framework, in accordance with some embodiments of the present disclosure.

The student-teacher framework 200, illustrated by teacher portion 201 and student portion 203, is an example of a semi-supervised training method. In the student-teacher framework, the student portion 203 (e.g., classifier 208) is trained to generate data based on the output of the teacher portion 201 (e.g., the teacher model 256) during a training period. The classification pseudo labels 220 are the outputs of the input-output pair described as the synthetic data 114 in FIG. 1.

The classifier 208 is a sub-task model that is smaller than the teacher model 256 configured to perform a particular sub-task (e.g., a classification task). In operation, the classifier 208 has fewer layers, weights, and/or nodes than the layers, weights and/or nodes of the teacher model 256, making the classifier 208 more computationally efficient than the teacher model 256 by virtue of performing less processing than the teacher model 256 as a result of the smaller architecture of the explanation model 308. The classifier 208 iteratively develops statistical correlations that enable the classifier 208 to classify a user's degree of fitness with respect to one or more criteria identified in a digital content item (e.g., a job posting). After the training period, the classifier 208 is trained to label one or more criteria identified in the job posting with respect to the abilities, skills, characteristics, experience, or features of a user defined using profile data.

The teacher model 256 of the teacher portion 201 is a domain-specific machine learning model. Because the teacher model 256 is domain-specific, the classification pseudo label 220 generated by the teacher model 256 is domain-specific. For example, whereas the seed data generator 152 described in FIG. 1 is capable of generating domain-neutral classification training data (e.g., identifying and matching a user's “work experience” defined in profile data to criteria identified in a job posting), the teacher model 256 is capable of generating domain-specific classification pseudo labels 220 (e.g., identifying an matching a user's “marketing work experience” defined in profile data to criteria identified in a job posting).

In operation, inputs 202 are fed to both the classifier 208 of the student portion 203 and the teacher model 256 of the teacher portion 201. The inputs 202 include digital content items such as profile data and a job posting. As described with reference to FIG. 1, the inputs 202 can include training data 136 such as seed data 154 (e.g., digital content items generated by the seed data generator 152, job postings 162, and profile data 164, and/or domain-neutral classifications generated by the seed data generator 152 as described in FIG. 1) or manual data 104 (e.g., classifications labeled by users of the user system 102 as described in FIG. 1). As described herein, the teacher model 256 of the teacher portion 201 is a domain-specific machine learning model that has been previously trained to perform classifications of a user's fitness. The classification of the user's fitness (e.g., classification pseudo labels 220) corresponds to the synthetic data 114 described in FIG. 1. The classification pseudo label 220 output from the teacher model 256 represents a degree of matching corresponding to a user's fitness with respect to user information included in profile data and one or more criteria identified in a job posting.

Training the classifier 208 of the student portion 203 using the classification pseudo label 220 generated by the teacher model 256 is one example of transferring or otherwise distilling domain-specific information. By generating the classification pseudo labels 220 using the domain-specific information learned by the teacher model 256, the classifier 208 captures the domain-specific information learned by the teacher model 256 without explicitly being trained using such domain-specific information.

The classification pseudo label 220 becomes the training output of the input-output pair used to train the classifier 208 to determine classifications of a user's fitness with respect to one or more criteria of a job posting. The generated input-output pairs (e.g., the input 202 and classification pseudo label 220) reduce the need for manually labeled training data (e.g., manual data 104 described in FIG. 1) by supplementing any available manually labeled training data, thereby conserving computing resources associated with manually labeling training data.

The classifier 208 of the student portion 203 predicts output 206 by applying nodes in one or more layers of the classifier 208 to the input 202. As described herein, a layer may refer to a sub-structure of a machine learning model that includes a number of nodes (e.g., neurons) that perform a particular computation and is connected to nodes of adjacent layers. Nodes in each of the layers sum up values from adjacent nodes and apply an activation function, allowing the layers to detect nonlinear patterns in the input data. Nodes are interconnected by weights, which are tuned during training. In operation, the nodes of the classifier 208 are adjusted based on an error determined by comparing the classification pseudo label 220 to the predicted output 206. The adjustment of the weights during the training period facilitates the classifier 208 ability to classify a user's fitness with respect to one or more criteria identified in a digital content item (e.g., a job posting).

The comparator 210 compares the predicted output 206 to the classification pseudo label 220 to determine an amount of error or difference between the predicted output 206 and the classification pseudo label 220. For example, the comparator 210 can compute the error between the predicted output 206 to the classification pseudo label 220 using the square error function, the root mean square error function, and/or the cross-entropy error function, for instance. In operation, the comparator 210 compares the likelihood of each class determined by the classifier 208 (e.g., predicted output 206) to the likelihood of each class determined by the teacher model 256 (e.g., classification pseudo label 220).

The error signal 212 is used to adjust the weights of the classifier 208 such that after a set of training iterations, the classifier 208 iteratively converges, e.g., changes (or learns) over time to generate an acceptably accurate predicted output 206 using the classification pseudo labels 220 determined from the teacher portion 201. The classifier 208 generates an acceptably accurate predicted output 206 when the error between the predicted output 206 and the classification pseudo labels 220 satisfies a defined tolerance or confidence level, for instance.

The classifier 208 of the student portion 203 receives the benefit of developing statistical correlations that are similar to those teacher model 256 of the teacher portion 201 by virtue of training the predicted output 206 using the pseudo labels 218, even though the classifier 208 is more efficient than the teacher model 256 (e.g., the classifier 208 has fewer nodes than the teacher model 256, fewer weights than the teacher model 256, fewer layers than the teacher model 256, a different architecture from the teacher model 256).

FIG. 3 is an example flow diagram for training the explanation sub-task model for a content generation sub-task using a student-teacher framework, in accordance with some embodiments of the present disclosure.

Similar to the student-teacher framework described in FIG. 2, the student teacher framework 300 of FIG. 3 includes a student portion 303 that is trained to generate data based on the output of the teacher portion 301 during a training period. The explanation model 308 is a sub-task model that is smaller than the teacher model 356 configured to perform a particular sub-task (e.g., an content generation task). In operation, the explanation model 308 has fewer layers, weights, and/or nodes than the layers, weights and/or nodes of the teacher model 356, making the explanation model 308 more computationally efficient than the teacher model 356 by virtue of performing less processing than the teacher model 356 as a result of the smaller architecture of the explanation model 308. The explanation model 308 iteratively develops statistical correlations that enable the explanation model 308 to generate content that explains or provides reasoning for classifications output by the classifier sub-task model (e.g., classifier 112 described in FIG. 1, classifier 208 described in FIG. 2, or classifier 412 described in FIG. 4). In other words, the explanation model 308 learns to generate natural language text that supports the classifications determined by the classifier sub-task model. As a result a user is presented with an evaluation of the user's fitness using a natural text explanation based on the classification of the user's degree of fitness with respect to one or more criteria identified in a digital content item (e.g., the classification pseudo label 320). After the training period, the explanation model 308 is trained to generate content (e.g., natural language text).

Similar to the teacher model 256 described in FIG. 2, the teacher model 356 of the teacher portion 301 is trained using domain-specific data, making it a domain-specific machine learning model. Because the teacher model 356 is domain-specific, the classification pseudo label 320 is domain specific. Similarly, the explanatory content pseudo label 318 is domain specific. For example, whereas the seed data generator 152 described in FIG. 1 is capable of generating domain-neutral explanatory content, the teacher model 356 is capable of generating domain-specific explanatory content pseudo labels 318.

In operation, inputs 302 are fed to both the explanation model 308 of the student portion 303 and the teacher model 356 of the teacher portion 301. Similar to the description of the inputs 202 described in FIG. 2, the input 302 can include training data 136 such as seed data 154 (e.g., digital content items generated by the seed data generator 152, job postings 162, and profile data 164, and/or domain-neutral classifications and explanatory content generated by the seed data generator 152 as described in FIG. 1) or manual data 104 (e.g., classifications and/or explanatory content labeled by users of the user system 102 as described in FIG. 1. As described herein, the teacher model 356 of the teacher portion 301 is a domain-specific machine learning model that has been previously trained to perform classifications of a user's fitness and generate explanatory context for the classification with respect to a user profile and a digital content item (e.g., the criteria identified in the digital content item). The classification pseudo label 320 output from the teacher model 356 represents a degree of matching corresponding to a user's fitness with respect to user information included in profile data and one or more criteria identified in a job posting. As described herein, the explanation model 308 generates explanatory content of a classification. Accordingly, the explanation model 308 of the student portion 303 receives the classification pseudo label 320 generated by the teacher model 356 of the teacher portion 301. The explanatory pseudo labels 318 generated by the teacher model 356 represents content that includes reasoning logic explaining the classification pseudo label 320. The explanatory content pseudo label 318 and the classification pseudo label 320 are considered the synthetic data 114 as described in FIG. 1.

Training the explanation model 308 of the student portion 303 using the explanatory content pseudo labels 318 generated by the teacher model 356 is one example of transferring or otherwise distilling domain-specific information. By generating the explanatory content pseudo labels 318 using the domain-specific information learned by the teacher model 356, the explanation model 308 captures the domain-specific information learned by the teacher model 356 without explicitly being trained using such domain-specific information.

As described herein, the generated input-output pairs (e.g., the input 302 and classification pseudo label 320 and corresponding explanatory content pseudo label 318) reduce the need for manually labeled training data (e.g., manual data 104 described in FIG. 1) by supplementing any available manually labeled training data, thereby conserving computing resources associated with manually labeling training data.

The explanation model 308 of the student portion 303 predicts output 306 by applying nodes in one or more layers of the explanation model 308 to the input 302 and the classification pseudo label 320. The nodes of the explanation model 308 are adjusted based on an error determined by comparing the explanatory content pseudo label 318 to the predicted output 306. The adjustment of the weights during the training period facilitates the explanation model's 308 ability to generate explanatory logic associated with the classification of a user's fitness with respect to one or more criteria identified in a digital content item (e.g., a job posting).

The comparator 310 compares the predicted output 306 to the explanatory content pseudo label 318 to determine an amount of error or difference between the predicted output 306 and the explanatory content pseudo label 318. For example, if the predicted output 306 and the explanatory content pseudo label 318 are natural language text, then the comparator 310 can compute the error using any natural language processing evaluation metric. For example, the comparator 310 can evaluate the explanatory content pseudo label 318 by calculating a recall-oriented understudy for Gisting Evaluation (ROUGE) score.

Determining the error signal 312 using the ROUGE score involves calculating, by the comparator 310, a recall score and a precision score. The recall score is an indication of how much content included in the explanatory content pseudo label 318 is the content (or semantically similar content) included in the predicted output 306. For example, the recall score can be a ratio of the overlapping number of tokens between the content included in the explanatory content pseudo label 318 and the content in the predicted output 306, to the total number of tokens of the explanatory content pseudo label 318. The precision score is an indication of the relevance of the content in the predicted output 306 with respect to the explanatory content pseudo label 318. For example, the precision score can be a ratio of the overlapping number of tokens between the content in the predicted output 306 and the explanatory content pseudo label 318 to the total number of tokens in the content of the predicted output 306. The precision score and/or recall score can be passed to explanation model 308 as part of error signal 312.

The error signal 313 is used to adjust the weights in the explanation model 308 such that after a set of training iterations, the explanation model 308 iteratively converges, e.g., changes (or learns) over time to generate an acceptably accurate predicted output 306 using the explanatory content pseudo labels 318 determined from the teacher portion 301. The explanation model 308 generates an acceptably accurate predicted output 306 when the error between the predicted output 306 and the explanatory content pseudo label 318 satisfies a defined tolerance or confidence level, for instance.

The explanation model 308 of the student portion 303 receives the benefit of developing statistical correlations that are similar to those teacher model 356 of the teacher portion 301 by virtue of training the predicted output 306 using the explanatory content pseudo labels 318, even though the explanation model 308 is more efficient than the teacher model 356 (e.g., the explanation model 308 has fewer nodes than the teacher model 356, fewer weights than the teacher model 356, fewer layers than the teacher model 356, a different architecture from the teacher model 356). As a result, the explanation model 308 performs at least as well as the teacher model 356 (in terms of accuracy, confidence, or the like), even though the explanation model 308 is more efficient than the teacher model 356.

FIG. 4 is a flow diagram of an example method for deploying a sequence of sub-task models during inference, in accordance with some embodiments of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In the example of FIG. 4, computing system 400 includes a user system 402, and an application software system 430. Application software system 430 is any type of application software system that provides or enables at least one type of response to a user query to be presented to a user system. Examples of application software system 430 include but are not limited to connections network software, such as social media platforms, and systems that are or are not based on connections network software, such as general-purpose search engines, job search software, recruiter search software, sales assistance software, content distribution software, learning and education software, or any combination of any of the foregoing.

User system 402 includes at least one computing device, such as a personal computing device, a server, a mobile computing device, or a smart appliance. User system 402 includes at least one software application, enabling the user system 402 to bidirectionally communicate with the application software system 430. Additionally, the user system 402 can include a user interface that allows a user to generate or otherwise upload digital content items (e.g., user resume, article, blog post, job post, etc.). The user interface enables the user of the user system 402 to interact with digital content items (e.g., click on or otherwise interact with buttons, sliders, features (such as “liking” a digital content item or “sharing” a digital content item) and the like.

The query 454 is an input from a user using user system 402. In some embodiments, the query 454 is natural language text input, an interaction with a button (or other feature) presented to the user, or an audio input by a user. In some embodiments, the query 454 is a predetermined query from a set of predetermined queries and the user interacts with the predetermined query by clicking on or otherwise selecting the predetermined query from the set of predetermined queries. In some embodiments, the query 454 is generated by one or more upstream applications or services (not shown) and passed to the sequence selector 420.

The sequence selector 420 selects a sequence of sub-task models 410 to be executed, depending on a target task identified in the query 454. The sequence of sub-task models 110 described in FIG. 1, including the classifier 112 (e.g., a first sub-task model of the sequence of sub-task models 410) and the explanation model 116 (e.g., a second sub-task model of the sequence of sub-task models 410), is one example sequence of sub-task models that can be selected by the sequence selector 420. It should be appreciated that other sequences of sub-task models can be selected by the sequence selector 420. Each sequence of sub-task models 410 can include at least in part, at least two machine learning models (e.g., sub-task models) arranged in a cascade, where one machine learning model output is input to another machine learning model. Each sub-task model of a sequence of sub-task models 410 is configured to perform a sub-task associated with a target task identified in the query 454. In other words, each sequence of sub-task models 410 is associated with a target task.

In operation, the sequence selector 420 maps a target task identified in query 454 to a sequence of sub-task models 410 configured to perform the task. For example, the query 454 “am I a good fit for X job position” is an evaluation task in which the fitness or applicability of the user of the user system 402 with respect to the target of the query 404 (e.g., the X job position) is determined. The evaluation task is decomposed into a sequence of dependent sub-tasks using a sequence of sub-task models 410 such as evaluating whether the user of the user system 402 satisfies one or more criterion identified in the target of the query 404 and conveying the user's fitness with respect to the target of the query 404 to the user via response 456. As described herein, the evaluation task (e.g., the target task identified in the query 454) is divided into a first sub-task performed by the classifier 412 (e.g., a classification task) to classify the user's fitness with respect to the target of the query 404. The evaluation task is further divided into a second sub-task performed by the explanation model 416 (e.g., an explanatory reasoning task) to generate an explanation for the classification of the user's fitness with respect to the target of the query 404.

In operation, the sequence selector 420 selects a sequence of sub-task models 410 from a set of sequences of sub-task models 410 according to the task identified in the query 454. In some embodiments the sequence selector 420 uses string matching or a semantic similarity analysis to identify target tasks in the query 454. Responsive to identifying a target task in the query 454, the sequence selector maps the target task (e.g., using a mapping table, for instance) to a sequence of sub-task models 410 such that a set of sub-task models in a sequence of sub-task models 410 are executed to each perform a sub-task in furtherance of the target task. In some embodiments, the sequence selector 420 is a generative language model that receives the query 454 as an input (e.g., as part of a prompt) and generates a target task. In some embodiments, the target tasks generated by the sequence selector 420 are constrained to a set of predefined target tasks that each map to a sequence of sub-task models 410. In yet other embodiments, the sequence selector 420 selects a sequence of sub-task models according to a selection of a predetermined query. For example, a user selection of a predetermined query maps to a sequence of sub-task models.

Responsive to selecting a sequence of sub-task models based on the query 454, the first sub-task model of the sub-task models 410 receive content items 460 such as a target of the query 404 and profile data 406. The target of the query 404 corresponds to a digital content item associated with the query 454 of the user. For example, the target of the query 404 can include a job posting. Profile data 406 corresponds to information associated with the user of the user system 402 (e.g., resume and profile information). In some embodiments, when the user of the user system 402 initiates query 454, a user identifier maps the user of the user system 402 to profile data 406 (e.g., via IP address, username, or other specific user identifier). The profile data 406 is used to provide the sub-task models 410 information about the user of the user system 402.

As described herein, the classifier 412 performs a classification task, classifying a user's fitness (as identified using user data obtained via the profile data 406) with respect to one or more criteria identified in the target of the query 404. The classifier 412 passes one or more classifications 418 to the explanation model 416 to generate explanatory content of the classification 418 with respect to the target of the query 404 based on the user data obtained via the profile data 406. For example, the target of the query 404 can be a job posting describing one or more criterion associated with the job. For instance, the job posting can be for a chef position, and a criterion of the one or more criterion defined in the job posting is “5+years of baking experience.” Given a user resume (e.g., part of profile data 406) that states that a user has 5 years of cooking experience, the classifier 412 determines that the classification 418 with respect to the target of the query 404 based on the user data obtained via the profile data 406 is a “partial match.” The explanation model 416 receives the “partial match” classification, as well as the target of the query 404 and the profile data 406. The explanation model 416 can generate natural language text that explains that the user is a “partial match” because it is unclear, given the user information, whether the user's cooking experience is baking experience. The natural language text is output to the user as part of the response 456.

In some embodiments, the classifier 412 passes a classification 418 of each criterion identified in the target query with respect to the user's fitness. In some embodiments, the classifier 412 passes a classification 418 for one or more groups of criteria identified in the target query with respect to the user's fitness (e.g., a classification of the user with respect to all of the “required qualifications” identified in a job posting). In some embodiments, the classifier 412 passes a classification 418 for a total classification of a group of criteria using a classification of the criterion in the group. For example, the classifier 412 can classify the user's fitness with respect to all of the qualifications in a job posting in totality.

As described herein, using the classification 418, the target of the query 404, and the profile data 406, the explanation model generates content that is understandable to a user such as natural language text. The generated content provides a reasoning for the classification of the user's fitness with respect to the target of the query 404 (e.g., a criterion identified in the job posting, a group of criteria identified in the job posting, the user's fitness with respect to the job posting in its entirety, or the like). In some embodiments, the latency associated with performing the content generation task using the explanation model 416 is reduced by caching input information (e.g., information included a prompt to the explanation model 416).

The latency associated with performing the content generation task using the explanation model 416 can further be increased using speculative decoding. Speculative decoding is when one or more additional machine learning models (not shown) operate in parallel with the explanation model 416 to predict tokens and/or verify tokens predicted by the explanation model 416. Another technique to improve latency with performing the content generation task using the explanation model 416 includes quantization to truncate or otherwise compress weights of the explanation model 416. Other techniques to reduce latency or improve the efficiency and/or training of a sub-task model can be applied to the sub-task models of the sequence of sub-task models 410 (e.g., feedback optimization techniques such as self-play preference optimization to train generative models, pruning techniques).

The classification 418 and/or the content generated by the explanation model 416 are presented to the user via response 456. In some embodiments, the classification 418 and/or generated content are passed to one or more downstream models. For example, if a classification 418 indicates that a user does not satisfy a criterion indicated in the target of the query 404, a downstream model can identify a content recommendation that will enable the user to satisfy the criterion indicated in the target of the query 404. For example, the content recommendation can support the user's learning of a skill that was absent from the user, based on the profile data 406, but that is indicated as a criterion in the target of the query 404. The content recommendation, classification 418, and/or generated content can be provided to the user via response 456.

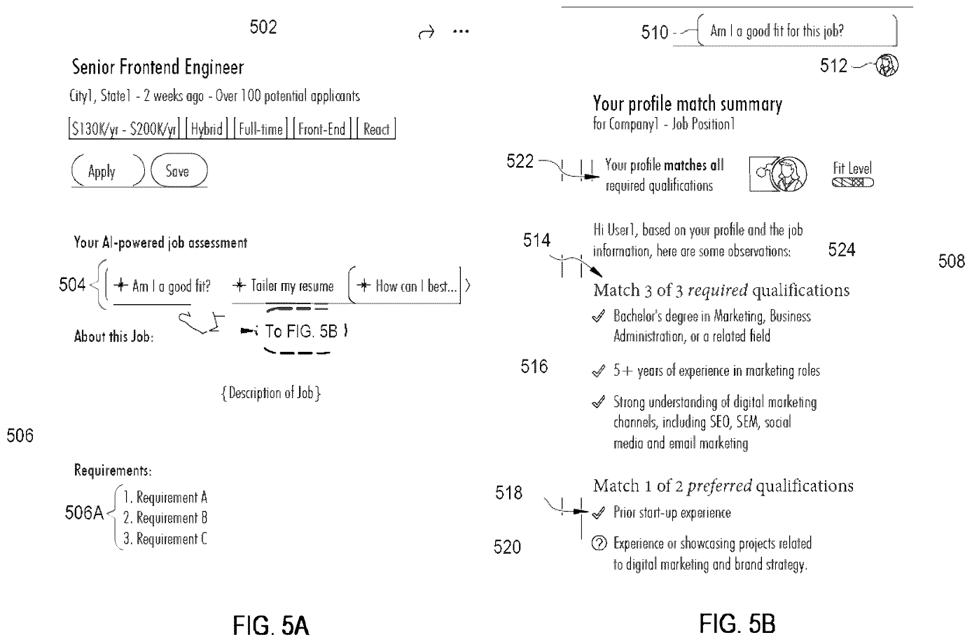

FIGS. 5A-5B illustrate an example user interface associated with deploying a sequence of sub-task models to perform a target task, in accordance with some embodiments of the present disclosure.

FIG. 5A illustrates one implementation of a user interface presented by an application software system (such as application software system 130 described in FIG. 1), to a user. For example, a user is presented with digital content item 502 (e.g., a job posting). The digital content item 502 includes information about the job posting 506. Included in the information about the job posting 506 is a list of criteria 506A.

In addition to the information about the job posting 506, a set of predetermined queries are presented to the user at 504. The user interacts with a predetermined query (e.g., by clicking on a button corresponding to a particular predetermined query) to initiate a query (such as query 454 described in FIG. 4). While predetermined queries are presented to the user at 504, it should be appreciated that a user can generate a query using a natural language text command, an audio command, or the like.

Responsive to interacting with the particular predetermined query, a popup window is generated, as illustrated in FIG. 5B, to present information to the user. While illustrated in FIG. 5B as popup window, it should be appreciated that other methods of presenting information can be used to respond to the user's query (e.g., the selection of a particular predetermined query of the predetermined queries 504). As shown in the popup window, the selected predetermined query is conveyed to the user as a chat message 510. User identification 512 associated with the chat message 510 is presented to the user such that the user understands their selected predetermined query selected from predetermined queries 504. As shown, user identification 512 is a user image, but other user identification can be presented to the user (e.g., username, user ID, etc.).

Responsive to the predetermined query, the application software system generates a response 508 (e.g., similar to response 456 described in FIG. 4). The response 508 is a generated response to the selected user query. As shown, the selected user query is “am I a good fit?” The response 508 evaluates the user's fitness (using the user's profile information, uploaded resume, or other digital content items) with respect to the criteria 506a identified in the information about the job posting 506.

In the response 508, a total user classification 522 with respect to the “required qualifications” identified in the criteria 506a is presented to the user. In addition, a visualization 524 of the user's fitness with respect to the job posting 506 is presented to the user.

The response 508 includes groups of criteria identified in the information about the job posting 506. In some embodiments, the groups of criteria are explicitly identified in the criteria 506a identified in the information about the job posting 506. For example, the information about the job posting 506 can include segments of “required qualifications” (e.g., a first group of criteria) and “preferred qualifications” (e.g., a second group of criteria). In some embodiments, a sub-task models of a sequence of sub-task models (not shown) can group criteria according to the context of the criteria 506a included in the information about the job postings 506. For example, while the job posting 506 may not explicitly group qualifications into groups of criteria as explained above, the job posting 506 can use natural language such as “ideal” or “favorable” in the description of criteria 506a. Responsive to such natural language in the description of the criteria 506a, one or more sub-task models can generate groups of criteria. For example, the explanation model (e.g., explanation model 416 described in FIG. 4 or explanation model 116 described in FIG. 1) can generate groups of criteria according to the context of the information of the job posting 506.

A first group of criteria identified in the response 508 is the “required qualifications.” Three qualifications identified in the criteria 506a of the job posting 506 have been grouped into the first group of criteria. As shown, the user's fitness with respect to the required qualifications is a “match” classification indicated at 514. In addition to the “match” classification indicated at 514, the response 508 presents the user with explanatory content 516 in furtherance of the classification “match” indicated at 514. In operation, a first sub-task model of a sequence of sub-task models (not shown) determines a classification of each criterion identified in the job posting with respect to the user's skills (obtained from user profile information, for instance). A second sub-task model of a sequence of sub-task models (not shown) receives the classification of each criterion and generates explanatory content for the classification. In some embodiments, the explanatory content is presented to the user as explanatory content 516.

As shown, the response 508 includes visualizations for each of the criteria 506a of the job posting 506. For example, if the first sub-task model identifies a positive classification such as “fit” or “good fit” or “match” or “great match,” a check mark 518 is associated with the positive classification. Other indicators can be associated with positive classifications. Similarly, if the first sub-task model identifies a negative or uncertain classification such as “not fit” or “uncertain,” a question mark 520 is associated with the negative classification. Other indicators can be associated with negative classifications.

The structured output of response 508, including visualizations such as question marks 520, check marks 518, and visualization 524, explanatory content 516, and groups of criteria (such as “required qualification” group or “preferred qualification”) increase user trust associated with a performance of a target task (e.g., evaluation of user fitness with respect to the job posting 506). The response 508 is structured by virtue of the sequence of sub-tasks used to perform the target task (such as the sequence of sub-task models 410 described in FIG. 4).

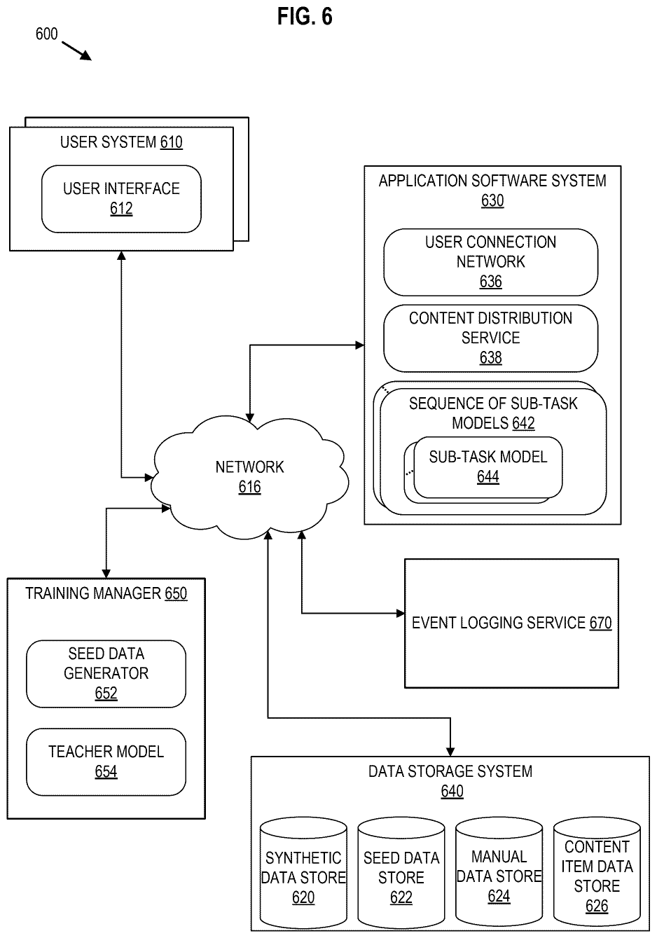

FIG. 6 is a block diagram of a computing system that includes a sequence of sub-task models, in accordance with some embodiments of the present disclosure.

In the embodiment of FIG. 6, a computing system 600 includes one or more user systems 610, a network 616, an application software system 630, a training manager 650, and a data storage system 640.

As indicated in FIG. 6, components of computing system 100 are distributed across multiple different computing devices, e.g., one or more client devices, application servers, web servers, and/or database servers, connected via a network, in some implementations. For example, in FIG. 6 the components of the training manager 650 and/or sequence of sub-task models 642 are implemented using an application server or server cluster, which can include a secure environment (e.g., secure enclave, encryption system, etc.) for the processing of search query data. In some embodiments, all or at least some components of the sequence of sub-task models 642 are implemented at the user system 610. For example, the sequence of sub-task models 642 can be implemented directly upon a single client device and/or the application software system 630 without the need to communicate with, e.g., one or more servers over the Internet.

A user system 610 includes at least one computing device, such as a personal computing device, a server, a mobile computing device, or a smart appliance, and at least one software application that the at least one computing device is capable of executing, such as an operating system or a front end of an online system. In some embodiments, a user of user system 610 can be an administrator such as a user creating manual training data including evaluations of criteria identified in a job posting with respect to a particular user. The evaluations can include classifications of one or more criterion indicated in the job posting with respect to the particular user and explanatory content indicating a reasoning for the classification. As described herein, the input of the input-output pair is the job posting and user information, and the output of the input-output pair is the evaluation. In some embodiments, a user of the user system 610 can be a user interacting with the application software system 630 and requesting the performance of a target task. For example, the user can generate a query, such as query 454 described in FIG. 4 requesting that the application software system 630 evaluate the user's fitness with respect to a target job posting.

Many different user systems 610 can be connected to network 616 at the same time or at different times. Different user systems 610 can contain similar components as described in connection with the illustrated user system 610. For example, many different end users of computing system 600 can be interacting with many different instances of application software system 630 through their respective user systems 610, at the same time or at different times.

User system 610 includes a user interface 612. User interface 612 is installed on or accessible to user system 610 by network 616. The user interface 612 can include, for example, a graphical display screen that includes graphical user interface elements such as at least one input box or other input mechanism and at least one slot. A slot as used herein refers to a space on a graphical display such as a web page or mobile device screen, into which natural language text can be entered by a user and/or user selections are received. The locations and dimensions of a particular graphical user interface element on a screen are specified using, for example, a markup language such as HTML (Hypertext Markup Language). On a typical display screen, a graphical user interface element is defined by two-dimensional coordinates. In other implementations such as virtual reality or augmented reality implementations, a slot may be defined using a three-dimensional coordinate system.

In some implementations, user interface 612 enables the user to upload, download, receive, send, or share digital content items, including resumes, profile information, job postings, articles, comments, and shares. The user interface 612 also enables users to view or otherwise perceive outputs such as data and/or digital content produced by application software system 630 (e.g., a response generated by sub-task models 644 of the sequence of sub-task models 642) and/or content received by a user via content distribution service 638. For example, user interface 612 can include a graphical user interface (GUI), a conversational voice/speech interface, a virtual reality, augmented reality, or mixed reality interface, and/or a haptic interface. User interface 612 includes a mechanism for logging in to application software system 630, clicking or tapping on GUI user input control elements, and interacting with digital content. Examples of user interface 612 include web browsers, command line interfaces, and mobile app front ends. User interface 612 as used herein can include application programming interfaces (APIs).

In the example of FIG. 6, user interface 612 includes a front-end user interface component of application software system 630. For example, user interface 612 can be directly integrated with other components of any user interface of application software system 630. In some implementations, access to content of the application software system 630 is limited to registered users of application software system 630.

Network 616 includes an electronic communications network. Network 616 can be implemented on any medium or mechanism that provides for the exchange of digital data, signals, and/or instructions between the various components of computing system 600. Examples of network 616 include, without limitation, a Local Area Network (LAN), a Wide Area Network (WAN), an Ethernet network or the Internet, or at least one terrestrial, satellite or wireless link, or a combination of any number of different networks and/or communication links.

Application software system 630 includes any type of application software system that provides or enables the creation, evaluation, upload, display, and/or distribution of at least one form of digital content, including user profiles, articles, job postings, and videos between or among user systems, such as user system 610, through user interface 612. In some implementations, portions of the training manager 650 are components of application software system 630. Components of application software system 630 can include user connection network 636, content distribution service 638, and one or more sequence of sub-task models 642.

A front-end portion of application software system 630 can operate in user system 610, for example as a plugin or widget in a graphical user interface of a web application, mobile software application, or as a web browser executing user interface 612. In an embodiment, a mobile app or a web browser of a user system 610 can transmit a network communication such as an HTTP (HyperText Transfer Protocol) request over network 616 in response to user input that is received through a user interface provided by the web application, mobile app, or web browser, such as user interface 612. A request is formulated, e.g., by a browser or mobile app at a user device, in connection with a user interface event such as uploading or storing a digital content item. The request includes, for example, a network message such as an HTTP request to transfer data from an application front end to the application's back end, or from the application's back end to the front end, or, more generally, a request for a transfer of data between two different devices or systems, such as data transfers between servers and user systems. A server running application software system 630 can receive the input from the web application, mobile app, or browser executing user interface 612, perform at least one operation using the input, and return output to the user interface 612 using a network communication such as an HTTP response, which the web application, mobile app, or browser receives and processes at the user system 610.

In the example of FIG. 6, application software system 630 includes a user connection network 636. User connection network 636 includes, for instance, a social network service, professional social network software and/or other social graph-based applications. Application software system 630 can include, for example, online systems that provide social network services, general-purpose search engines, specific-purpose search engines, messaging systems, content distribution platforms, e-commerce software, enterprise software, or any combination of any of the foregoing or other types of software.

In the example of FIG. 6, application software system 630 includes a content distribution service 638. The content distribution service 638 can include a data storage service, such as a web server, which stores digital content items, uploaded by users, created by users, and/or searched for by users. Content distribution service 638 includes, for example, a chatbot or chat-style system, a messaging system, such as a peer-to-peer messaging system that enables the creation and exchange of messages among users of application software system 630, or a news feed. Such generated content can be stored in storage system 640 as content items of the content item data store 626. In some implementations, content distribution service 638 interfaces with application software system 630, for example, via one or more application programming interfaces (APIs).

In the example of FIG. 6, application software system 630 includes one or more sequences of sub-task models 642. Each sequence of sub-task models 642 is associated with a target task. For example, a target task is divided into a sequence of sub-tasks, where each of the sub-tasks associated with the target task are performed by a sub-task model 644. Each sequence of sub-task models 642 includes at least two sub-task models 644 arranged in a cascade where one sub-task model output is input to another sub-task model. In a non-limiting example, an evaluation task is divided into a classification task and a content generation task. The classification task is performed by a first sub-task model 644 of a sequence of sub-task models 642 and the content generation task is performed by a second sub-task model 644 of the sequence of sub-task models 642.

In the example of FIG. 6, the training manager 650 includes a seed data generator 652 and a teacher model 654 to train the sub-task models 644 of the sequence of sub-task models 642.

The seed data generator 652 can be any machine learning model configured to generate seed data 154 stored in the seed data store 622. For example, the seed data generator 652 can be a domain-neutral or out of the box machine learning model. Because the seed data generator 652 is domain-neutral, the seed data 154 is domain-neutral.

The seed data generated by the seed data generator 652 can include a one-pass approach to the sub-tasks. For example, if a first sub-task is a classification task and a second sub-task is an explanation task, the seed data generator 652 generates seed data that both classifies and generates an explanatory response in a single pass. In some embodiments, the seed data generator 652 is executed a number of times equal to a number of sub-tasks. For example, the seed data generator 652 is executed a first time to generate classification seed data, and the seed data generator 652 is executed a second time to generate explanatory seed data.

The teacher model 654 can be any domain-specific machine learning model configured to generate synthetic data stored in the synthetic data store 620. The purpose of the teacher model 654 is to increase the volume of training data by generating synthetic data. Additionally, because the teacher model 654 is domain-specific, the synthetic data generated by the teacher model 654 is domain-specific. For example, whereas the seed data generator 652 is capable of generating seed data associated with “work experience” generally, the teacher model 654 is capable of generated synthetic data associated with “marketing work experience” or some other domain-specific work experience. In operation, the teacher model 654 receives the seed data generated by the seed data generator 652 and generates synthetic data, which is more voluminous than the seed data, by virtue at least in part of the inclusion of domain-specific information.

Event logging service 670 captures and records network activity data generated during operation of application software system 630, including user interface events generated at user systems 610 via user interface 612, in real time, and formulates the user interface events into a data stream that can be consumed by, for example, a stream processing system. Examples of network activity data include profile views, profile loads, search requests, clicks on messages or graphical user interface control elements, the creation, editing, sending, and viewing of job postings or other digital content items. For instance, when a user of application software system 630 via a user system 610 clicks on a user interface element, such as a message, a link, or a user interface control element such as a view, comment, share, or reaction button, or uploads a file, or creates a message, loads a web page, or scrolls through a feed, etc., event logging service 670 fires an event to capture an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web or mobile.

For instance, when a user interacts with a content item such as a job posting, the event logging service 670 stores the corresponding event data in a log. Event logging service 670 generates a data stream that includes a record of real-time event data for each user interface event that has occurred. Event data logged by event logging service 670 can be pre-processed and anonymized as needed so that it can be used, for example, as part of synthetic data stored in the synthetic data store 620 and/or as manual data stored in the manual data store 624.

Data storage system 640 includes data stores and/or data services that store digital data received, used, manipulated, and produced by application software system 630 and/or training manager 650, including a synthetic data store 620, a seed data store 622, a manual data store 634, and a content item data store 626.

As described herein, the synthetic data store 620 stores synthetic data generated by the teacher model 654 for use in training the sequence of sub-task models 642. The seed data store 622 stores seed data generated by the seed data generator 652 for use in generating synthetic data.

The manual data store 624 stores manual data. Manual data is user-determined input-output pairs. The input-output pairs depend on the target task. For example, given an evaluation task divided into a classification task and a content generation task, the input of the input-output pair is the job posting and user information, and the output of the input-output pair is the classification of the user's fitness (e.g., an indication of how well the user's skills and/or attributes match or semantically match criteria identified in the job posting) and corresponding explanatory content (e.g., an explanation of the classification based on the matching or semantic matching of the user's skills and/or attributes with respect to the criteria identified in the job posting).

Obtaining the manual data stored in the manual data store 624 is costly, time-consuming, and error prone. Accordingly, the amount of manual data used by the training manager 650 to train the sequence of sub-task models 642 is limited. The seed data generator 652 and teacher model 654 expand or otherwise supplement the limited set of manual data 104 used for training the sub-task models 644 by generating seed data input-output pairs, seed data outputs (e.g., classifications and explanatory content), synthetic data input-output pairs, synthetic data outputs, or some combination.

The content item data store 626 stores digital content items hosted by the application software system 630, generated by the application software system 630, uploaded to the application software system 630, and the like. Digital content items include any digital content provided by the application software system 630 that can be presented to the user using the user system 610 (e.g., using audio and/or natural language text). For example, digital content items can job postings and user profiles.

A job posting is a digital content item with content describing a job associated with an entity. The job posting can include information about the job and the entity associated with the job. Job postings include one or more criteria associated with the job. The criteria indicate skills, attributes, experience, or characteristics a user must have or satisfy to be considered a candidate for the job posting. The more criteria that are satisfied by the user correspond to the user being a better fit for the job.

Profile data can include any information associated with a user. For example, when a user interacts with an application of the application software system 630, the user provides personal information, such as a name, age (e.g., birthdate), gender, interests, contact information, home town, address, spouse's and/or family members' names, educational background (e.g., schools, majors, matriculation and/or graduation dates, etc.), employment history, skills, interests, professional, employment history, area of expertise, organizations, and so on. Some or all of such information can be stored as profile data. Profile data may also include profile data of various organizations/entities (e.g., companies, schools, etc.).

In some embodiments, digital content items stored in the content item data store 626 are tagged with privacy settings such that only users with one or more credentials have access to the tagged digital content.

In some embodiments, the data storage system 640 includes multiple different types of data storage and/or a distributed data service. As used herein, data service may refer to a physical, geographic grouping of machines, a logical grouping of machines, or a single machine. For example, a data service may be a data center, a cluster, a group of clusters, or a machine. Data stores of the data storage system 640 can be configured to store data produced in real-time and/or offline (e.g., batch) data processing. Data stored in real time is data that is stored as soon as the data is received by the data storage system 640. A data store configured for real-time data processing can be referred to as a real-time data store. A data store configured for offline or batch data processing can be referred to as an offline data store. Data stores can be implemented using databases, such as key: value stores, relational databases, and/or graph databases. Data can be written to and read from data stores using query technologies, e.g., SQL or NoSQL.

A key: value database, or key: value store, is a nonrelational database that organizes and stores data records as key: value pairs. The key uniquely identifies the data record, i.e., the value associated with the key. The value associated with a given key can be, e.g., a single data value, a list of data values, or another key: value pair. For example, the value associated with a key can be either the data being identified by the key or a pointer to that data. A relational database defines a data structure as a table or group of tables in which data are stored in rows and columns, where each column of the table corresponds to a data field. Relational databases use keys to create relationships between data stored in different tables, and the keys can be used to join data stored in different tables. Graph databases organize data using a graph data structure that includes a number of interconnected graph primitives. Examples of graph primitives include nodes, edges, and predicates, where a node stores data, an edge creates a relationship between two nodes, and a predicate is assigned to an edge. The predicate defines or describes the type of relationship that exists between the nodes connected by the edge.

The data storage system 640 resides on at least one persistent and/or volatile storage device that can reside within the same local network as at least one other device of computing system 600 and/or in a network that is remote relative to at least one other device of computing system 600. Thus, although depicted as being included in computing system 600, portions of data storage system 640 can be part of computing system 600 or accessed by computing system 600 over a network, such as network 616.

While not specifically shown, it should be understood that any of user system 610, application software system 630, training manager 650, event logging service 670, and data storage system 640 includes an interface embodied as computer programming code stored in computer memory that when executed causes a computing device to enable bidirectional communication with any other of user system 610, application software system 630, training manager 650, event logging service 670, or data storage system 640 using a communicative coupling mechanism. Examples of communicative coupling mechanisms include network interfaces, inter-process communication (IPC) interfaces and application program interfaces (APIs).

Each of user system 610, application software system 630, training manager 650, event logging service 670, and data storage system 640 is implemented using at least one computing device that is communicatively coupled to electronic communications network 616. Any of user system 610, application software system 630, training manager 650, event logging service 670, and data storage system 640 can be bidirectionally communicatively coupled by network 616. User system 610 as well as other different user systems (not shown) can be bidirectionally communicatively coupled to application software system 630 and/or training manager 650.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 610, application software system 630, training manager 650, event logging service 670, and data storage system 640 are implemented using computer software, hardware, or software and hardware, and can include combinations of automated functionality, data structures, and digital data, which are represented schematically in the figures. User system 610, application software system 630, training manager 650, event logging service 670, and data storage system 640 are shown as separate elements in FIG. 6 for ease of discussion but, except as otherwise described, the illustration is not meant to imply that separation of these elements is required. The illustrated systems, services, and data stores (or their functionality) of each of user system 610, application software system 630, training manager 650, event logging service 670, and data storage system 640 can be divided over any number of physical systems, including a single physical computer system, and can communicate with each other in any appropriate manner.

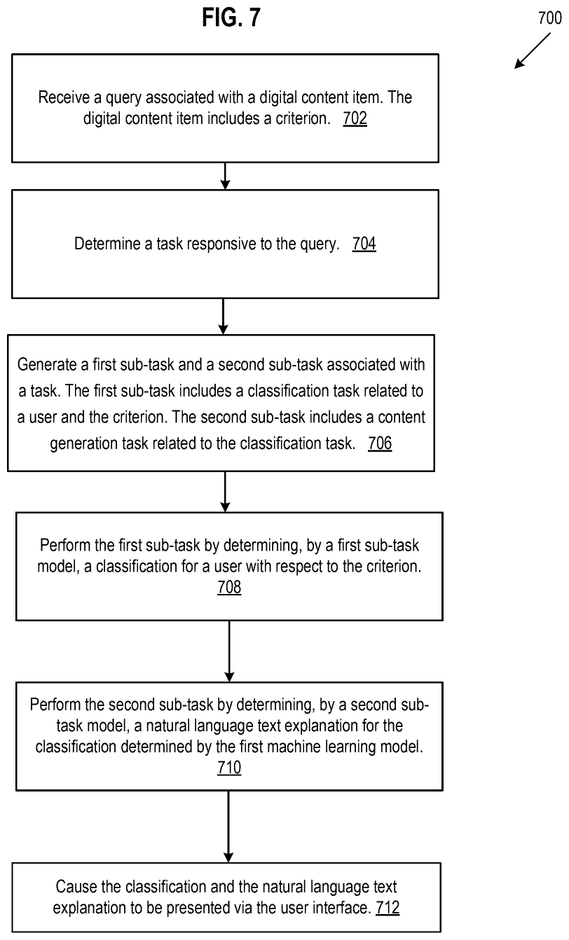

FIG. 7 is a flow diagram of an example method for deploying a sequence of sub-task models to perform a target task, in accordance with some embodiments of the present disclosure.

The method 700 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, one or more portions of method 700 is performed by one or more components of the training manager 650 or sequence of sub-task models 642 of FIG. 6, or the training manager 150 or sequence of sub-task models 110 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

At operation 702, a processing device receives, via a user interface, a query associated with a digital content item. The digital content item includes a criterion. The digital content item can be a job posting that identifies criteria that a user should match to be identified as a candidate for the job posting. The more criteria that are satisfied by the user (e.g., the user has skills, experience, characteristics, certifications, etc. that match the criteria in the job posting) correspond to the user being a better fit for the job.

In some embodiments, the criteria of the job posting are explicitly grouped. For example, the job posting can include “required” criteria with a list of specific degrees, qualifications, or certifications (e.g., “a Bachelor's degree in Electrical Engineering”). In some embodiments, the criteria of the job posting are grouped implicitly. For example, the context associated with the criterion can indicate a priority. For instance, a sentence describing the characteristics of “ideal candidates” can be used to generate a group of criteria associated with “required” criteria.

At operation 704, the processing device determines a task responsive to the query. As described herein, a sequence selector can use string matching or a semantic similarity analysis to identify target tasks responsive to the query. Responsive to identifying a target task in the query, the sequence selector maps the target task (e.g., using a mapping table, for instance) to a sequence of sub-task models such that a set of sub-task models in a sequence of sub-task models are executed to each perform a sub-task in furtherance of the target task. The sequence selector can also be a generative language model that receives the query as an input (e.g., as part of a prompt) and generates a target task. The target tasks generated by the sequence selector can be constrained to a set of predefined target tasks that each map to a sequence of sub-task models. The sequence selector can also select a sequence of sub-task models according to a selection of a predetermined query. For example, a user selection of a predetermined query maps to a sequence of sub-task models.

At operation 706, the processing device generates a first sub-task and a second sub-task associated with the task. Each sub-task performed by a sub-task model addresses a deficiency of the output associated with the target task. Generating sub-tasks from a target task injects structure into the output of the target task. In the evaluation task example, a first sub-task includes a classification task related to a user and the criterion of the digital content item. The classification sub-task of the sequence of sub-tasks divides the evaluation target task into a classification of the user's fitness with respect to one or more criterion identified in the digital content item. The second sub-task includes a content generation task related to (e.g., dependent on) the classification task. The content generation sub-task of the sequence of sub-tasks generates explanatory content based on the classifications identified by the first machine leaning model performing the first sub-task. As a result, a response to a user query such as “am I a good fit for this job,” performed by a sequence of sub-task models each performing a sub-task associated with the target task, is a structured response that identifies a classification of the user's fitness with respect to one or more criterion in the digital content item and explanatory content associated with the classification of the user's fitness.

At operation 708, the processing device performs the first sub-task by determining, by a first machine learning model, a classification for a user with respect to the criterion. An input to the first machine learning model comprises the digital content item and user information. The first machine learning model performs a classification task that classifies a user's fitness. The user's fitness is a metric that represents the degree of matching between profile data associated with the user (e.g., a user profile, a user resume) and the digital content item (e.g., a job posting). A higher degree of matching corresponds to a higher user fitness with respect to the job posting. For example, a higher user's fitness represents criteria indicated in the job posting being mapped to user skills or attributes indicated in profile data. A lower degree of matching corresponds to a lower user fitness with respect to job posting. For example, a lower user's fitness represents criteria indicated in the job posting not being mapped (or partially being mapped) to the user skills or attributes indicated in the profile data. The first machine learning model classifies the user's fitness with respect to one or more criteria identified in the digital content item.

In some implementations, the first machine learning model is trained to perform the classification task using a first set of pseudo labels generated by a teacher model. The teacher model is a model that has been trained using domain-specific data to perform one or more sets of tasks. The teacher model is larger than the first machine learning model, in terms of the weights, nodes and/or layers used by the teacher model to perform a task. Training the first machine learning model using pseudo labels generated by the teacher model is one example of transferring or otherwise distilling domain-specific information. By generating the pseudo labels using the domain-specific information learned by the teacher model, the first machine learning model captures the domain-specific information learned by the teacher model without explicitly being trained using such domain-specific information.

In some implementations, the first set of pseudo labels are domain-specific classification pseudo labels generated using domain-neutral seed data generated by a seed data generator. The seed data generator is an out of the box or generic machine learning model that is trained to perform tasks using domain-neutral data (e.g., publicly available data). The teacher model receives the seed data generated by the seed data generator and generates classification pseudo labels, which are more voluminous than the seed data including digital content items (such as job postings and user profiles) and corresponding classifications of a user with respect to the criteria of the job posting, by virtue at least in part of the inclusion of domain-specific information.

At operation 710, the processing device performs the second sub-task by determining, by a second machine learning model, a natural language text explanation for the classification determined by the first machine learning model. An input to the second machine learning model comprises the digital content item, user information, and the classification. The second machine learning model performs a content generation task in which the second machine learning generates content such as natural language text to provide reasoning for the classification determined by the first machine learning model.

In some implementations, the second machine learning model is trained to perform the content generation task using a second set of pseudo labels generated by a teacher model. The teacher model is a model that has been trained using domain-specific data to perform one or more sets of tasks. The teacher model is larger than the second machine learning model, in terms of the weights, nodes and/or layers used by the teacher model to perform a task. Training the second machine learning model using pseudo labels generated by the teacher model is one example of transferring or otherwise distilling domain-specific information. By generating the pseudo labels using the domain-specific information learned by the teacher model, the second machine learning model captures the domain-specific information learned by the teacher model without explicitly being trained using such domain-specific information.

In some implementations, the second set of pseudo labels are domain-specific content pseudo labels and the domain-specific classification pseudo labels generated using domain-neutral seed data generated by the seed data generator. The seed data generator is an out of the box or generic machine learning model that is trained to perform tasks using domain-neutral data (e.g., publicly available data). The teacher model receives the seed data generated by the seed data generator and generates domain-specific content pseudo labels and the domain-specific classification pseudo labels, which are more voluminous than the seed data including digital content items (such as job postings and user profiles) and corresponding classifications of a user with respect to the criteria of the job posting and explanatory context, by virtue at least in part of the inclusion of domain-specific information.

At operation 712, the processing device causes the classification and the natural language text explanation to be presented via the user interface.

In some implementations, the method 700 further includes receiving, via the user interface, a second query associated with a second digital content item. The second digital content item includes a second criterion. The method 700 further includes determining a second task responsive to the second query. For example, the sequence selector described herein maps the content of the query to a second target task. The method 700 further includes dividing the second task into multiple sub-tasks. In some implementations, the sub-tasks of the multiple sub-tasks are different from the first sub-task and the second sub-task. In some implementations, the multiple sub-tasks include some combination of the first sub-task and/or the second sub-task. The method further includes performing each of the sub-tasks of the multiple of sub-tasks using respective machine learning models.

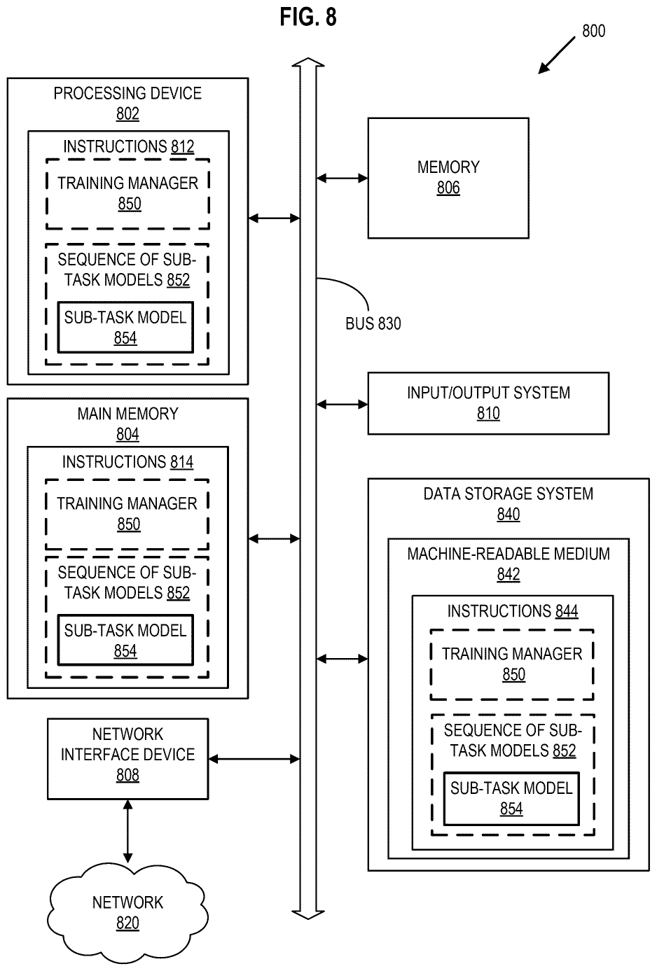

FIG. 8 is a block diagram of an example computer system including a training manager and a sequence of sub-task models, in accordance with some embodiments of the present disclosure.

In FIG. 8, an example machine of a computer system 800 is shown, within which a set of instructions for causing the machine to perform any of the methodologies discussed herein can be executed. In some embodiments, the computer system 800 can correspond to a component of a networked computer system (e.g., as a component of the training manager 650 or sequence of sub-task models 642 of FIG. 6, or the training manager 150 or sequence of sub-task models 110 of FIG. 1.) that includes, is coupled to, or utilizes a machine to execute an operating system to perform operations corresponding to one or more components of the training manager 650 or sequence of sub-task models 642 of FIG. 6, or the training manager 150 or sequence of sub-task models 110 of FIG. 1. For example, computer system 800 corresponds to a portion of computing system 100 when the computing system is executing a portion of the training manager 150 or sequence of sub-task models 110 of FIG. 1.

The machine is connected (e.g., networked) to other machines in a network, such as a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a memory 803 (e.g., flash memory, static random access memory (SRAM), etc.), an input/output system 810, and a data storage system 840, which communicate with each other via a bus 830.

Processing device 802 represents at least one general-purpose processing device such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be at least one special-purpose processing device such as an application specific integrated circuit (ASIC), a field programmable gate array (FPGA), a digital signal processor (DSP), network processor, or the like. The processing device 802 is configured to execute instructions 812 for performing the operations and steps discussed herein.

In some embodiments of FIG. 8, training manager 850 represents portions of training manager 650 of FIG. 6 when the computer system 800 is executing those portions of training manager 850. In some embodiments of FIG. 8, sequence of sub-task models 852 represents portions of the sequence of sub-task models 642 of FIG. 6 when the computer system 800 is executing those portions. Similarly, the sub-task model 854 of the sequence of sub-task models represents portions of the sub-task model 644 of FIG. 6 when the computer system 800 is executing those portions. Instructions 812 include portions of the training manager 850 and/or portions of the sub-task model 854 of the sequence of sub-task models 852 when those portions of the training manager 850 or sub-task model 854 of the sequence of sub-task models 852 are being executed by processing device 802. Thus, the training manager 850 and sequence of sub-task models 852 are shown in dashed lines as part of instructions 812 to illustrate that, at times, portions of the training manager 850 or sequence of sub-task models 852 are executed by processing device 802. For example, when at least some portion of the training manager 850 and/or sequence of sub-task models 852 and sub-task model 854 is embodied in instructions to cause processing device 802 to perform the method(s) described herein, some of those instructions can be read into processing device 802 (e.g., into an internal cache or other memory) from main memory 804 and/or data storage system 840. However, it is not required that all of the training manager 850, sequence of sub-task model 852 and/or sub-task model 854 be included in instructions 812 at the same time and portions of the training manager 850 sequence of sub-task model 852 and/or sub-task model 854 are stored in at least one other component of computer system 800 at other times, e.g., when at least one portion of the training manager 850 sequence of sub-task model 852 and/or sub-task model 854 is not being executed by processing device 802.

The computer system 800 further includes a network interface device 808 to communicate over the network 820. Network interface device 808 provides a two-way data communication coupling to a network. For example, network interface device 808 can be an integrated-services digital network (ISDN) card, cable modem, satellite modem, or a modem to provide a data communication connection to a corresponding type of telephone line. As another example, network interface device 808 can be a local area network (LAN) card to provide a data communication connection to a compatible LAN. Wireless links can also be implemented. In any such implementation network interface device 808 can send and receive electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 800.

Computer system 800 can send messages and receive data, including program code, through the network(s) and network interface device 808. In the Internet example, a server can transmit a requested code for an application program through the Internet and network interface device 808. The received code can be executed by processing device 802 as it is received, and/or stored in data storage system 840, or other non-volatile storage for later execution.

The input/output system 810 includes an output device, such as a display, for example a liquid crystal display (LCD) or a touchscreen display, for displaying information to a computer user, or a speaker, a haptic device, or another form of output device. The input/output system 810 can include an input device, for example, alphanumeric keys and other keys configured for communicating information and command selections to processing device 802. An input device can, alternatively or in addition, include a cursor control, such as a mouse, a trackball, or cursor direction keys for communicating direction information and command selections to processing device 802 and for controlling cursor movement on a display. An input device can, alternatively or in addition, include a microphone, a sensor, or an array of sensors, for communicating sensed information to processing device 802. Sensed information can include voice commands, audio signals, geographic location information, haptic information, and/or digital imagery, for example.

The data storage system 840 includes a machine-readable storage medium 842 (also known as a computer-readable medium) on which is stored at least one set of instructions 844 or software embodying any of the methodologies or functions described herein. The instructions 844 can also reside, completely or at least partially, within the main memory 804 and/or within the processing device 802 during execution thereof by the computer system 800, the main memory 804 and the processing device 802 also constituting machine-readable storage media. In one embodiment, the instructions 844 include instructions to implement functionality corresponding to the application software system 630 of FIG. 6 (e.g., training manager 650 or the sequence of sub-task models 642 and sub-task model 644).

Dashed lines are used in FIG. 8 to indicate that it is not required that the training manager 850 be embodied entirely in instructions 812, 814, and 844 at the same time. In one example, portions of the training manager 850 are embodied in instructions 814, which are read into main memory 804 as instructions 814, and portions of instructions 812 are read into processing device 802 as instructions 812 for execution. In another example, some portions of the training manager 850 are embodied in instructions 844 while other portions are embodied in instructions 814 and still other portions are embodied in instructions 812.

While the machine-readable storage medium 842 is shown in an example embodiment to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media. The examples shown in FIG. 8 and the accompanying description above are provided for illustration purposes. This disclosure is not limited to the described examples.

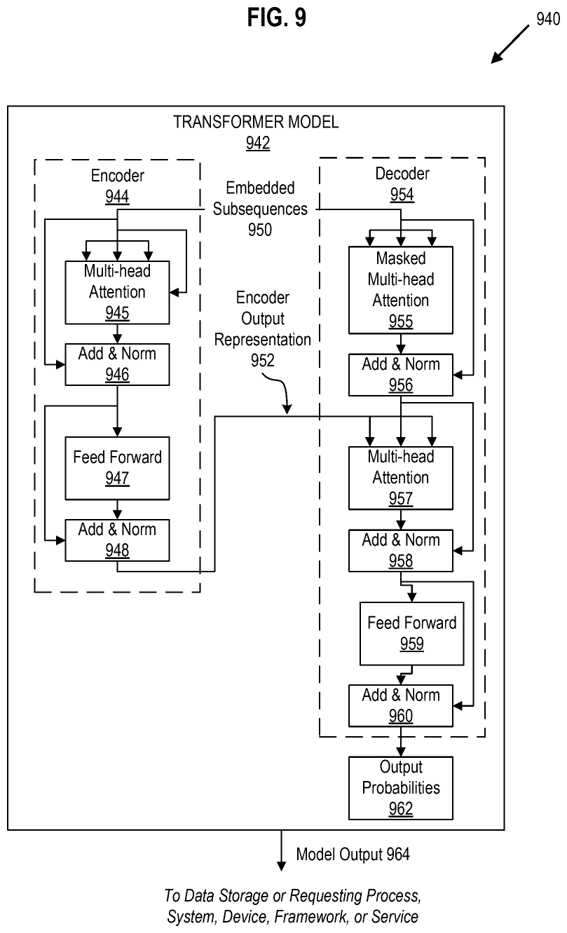

FIG. 9 is a block diagram of a machine learning model that can be used by and/or included in a generative model, in accordance with some embodiments of the present disclosure.

A specific example of a deep neural network is a sequence-to-sequence model, which takes sequential data such as words, phrases, or images (sequences of characters, tokens, or pixel values) or time series data as input and outputs sequential data. An example of a sequence-to-sequence model is an encoder-decoder model. In an encoder-decoder model, a first neural network known as an encoder transforms the model input into an encoded version of the model input, e.g., an embedding or vector. For example, an encoder can transform a sentence or an image into a sequence of numbers. A second neural network known as the decoder takes the output of the encoder (e.g., the encoded version of the model input) and decodes it. For example, a decoder can transform the sequence of numbers created by the encoder into a translated sentence or another form of output. The encoder-decoder model is suitable for sequence-to-sequence problems such as computer vision and natural language processing (NLP) tasks such as machine translation.

A specific example of an encode-decoder model is a transformer model. A transformer model is a deep neural network encoder-decoder model that uses a technique called attention or self-attention to detect relationships and dependencies among data elements in a sequence. Transformer models can be applied to various NLP tasks and other machine learning tasks, such as generating content based on input attributes or tokens. For example, the attention mechanism can facilitate the detection of semantic relationships and contextual dependencies between words and phrases.

In the example of FIG. 9, a machine learning system 940 includes a transformer model 942. The transformer model 942 is constructed using a neural network-based machine learning model architecture. In some embodiments, the neural network-based architecture includes one or more self-attention layers (e.g., multi-head attention layer 945, masked multi-head attention layer 955, and multi-head attention layer 957) that allow the model to assign different weights to different features included in the model input. Alternatively, or in addition, the neural network architecture includes feed-forward layers (e.g., feed-forward layer 947 and feed-forward layer 959) and residual connections (e.g., add & norm layer 946, add & norm layer 948, add & norm layer 956, add & norm layer 958, add & norm layer 960) that allow the model to machine-learn complex data patterns including predicting next tokens in a natural language processing context. In some embodiments, transformer model 942 is constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation of the generative model such as explanation model 116 described in FIG. 1, explanation model 416 described in FIG. 4, teacher model 156, and seed data generator 152 described in FIG. 1.

As shown in FIG. 9, transformer model 942 feeds embedded subsequences 950 into encoder 944 and decoder 954. For example, transformer model 942 feeds inputs of embedded subsequences 950 into multi-head attention layer 945 of encoder 944. In some embodiments, inputs of embedded subsequences 950 are a series of tokens and the output of the encoder (e.g., encoder output representation 952), is a fixed-dimensional representation for each of the tokens of embedded subsequences 950 including an embedding for inputs of embedded subsequences 950. Transformer model 942 feeds encoder output representation 952 and outputs of embedded subsequences 950 into decoder 954 which generates a sequence of tokens based on encoder output representation 952 and the input embeddings. While a specific architecture of encoder 944 and decoder 954 is shown for simplicity, as explained above, the exact number and arrangement of layers of each type as well as the hyperparameter values used to configure the model are determined based on the requirements of a particular design or implementation. Transformer model 942 can therefore include different numbers, arrangements, and types of layers, such that each input token of embedded subsequences 950 is fed through the layers of transformer model 942 and is dependent on other input tokens of embedded subsequences 950.

Transformer model 942 illustrates a generic encoder/decoder model for simplicity. In such a model, encoder 944 encodes the input into a fixed-length vector (e.g., encoder output representation 952) and decoder 954 decodes the fixed-length vector into an output sequence. Encoder 944 and decoder 954 are trained together to maximize the conditional log-likelihood of the output given the input. For example, once trained, encoder 944 and decoder 954 can generate an output given an input sequence or can score a pair of input/output sequences based on their probability of coexistence.

As shown in FIG. 9, encoder 944 includes multi-head attention layer 945, add & norm layer 946, feed-forward layer 947, and add & norm layer 948. Multi-head attention layer 945 receives inputs of embedded subsequences 950 and computes output representations for each of the input tokens of embedded subsequences 950 based on the inputs of embedded subsequences 950. For example, multi-head attention layer 945 converts each input token of embedded subsequences 950 into queries, keys, and values using query, key, and value matrices. Multi-head attention layer 945 computes the output representation of the input tokens of embedded subsequences 950 as the weighted sum of the values of all of the input tokens of embedded subsequences 950. Multi-head attention layer 945 computes the weights for the weighted sum by applying a compatibility function to the corresponding key and query for the value. For example, multi-head attention layer 945 uses a scaled dot product on the key and query of an input token to determine a weight to apply to a value of the input token. Multi-head attention layer 945 includes multiple attention blocks which each compute an output representation for the input token. Multi-head attention layer 945 aggregates the output representations of these attention blocks to generate a final output representation for multi-head attention layer 945.

Inputs of embedded subsequences 950 include information associated with the application software system (such as application software system 130 described in FIG. 1) at a given timestamp. For example, inputs of embedded subsequences 950 include the query 454 and content items 460 described in FIG. 4. Transformer model 942 feeds the output representation generated by multi-head attention layer 945 and residual connections from the inputs of embedded subsequences 950 into add & norm layer 946. By including these residual connections, transformer model 942 ensures that it does not “forget” features of embedded subsequences 950 during training. Forgetting in the context of machine learning can mean that as the model continues to be sequentially trained on different datasets, the model continually adjusts the values of feature coefficients based on the most recent datasets, thereby losing or diluting the effect on those coefficient values of the datasets used earlier in training.

Add & norm layer 946 sums the output representation generated by multi-head attention layer 945 and the residual connections from inputs of embedded subsequences 950 and applies a layer normalization to the result. In some embodiments, the add & normal layers also apply a SoftMax function to generate probabilities for the inputs of embedded subsequences 950. For example, the probability of a next token can be predicted in a natural language understanding context.

Transformer model 942 feeds the normalized output of add & norm layer 946 into feed-forward layer 947. Feed-forward layer 947 is a feed-forward network that receives the normalized output, feeds it through the layers of feed-forward layer 947, and then feeds the output of feed-forward layer 947 into add & norm layer 948. Feed-forward layer 947 processes the information received from add & norm layer 946 and can update the layers of feed-forward layer 947 based on the information (e.g., during training) and/or generate an output based on the layers processing the information (e.g., during evaluation and/or inference). For example, during training, transformer model 942 updates the weights of the layers of feed-forward layer 947 based on the inputs and the loss of the transformer model 942. As an alternative example, during evaluation and/or inference, the weights of the layers of feed-forward layer 947 are used to determine the output representation 952 of each of the input tokens of embedded subsequences 950.

Transformer model 942 feeds the output of feed-forward layer 947 into add & norm layer 948 as well as residual connections from the output of add & norm layer 946. Add & norm layer 948 sums the output of feed-forward layer 947 with the residual connections from add & norm layer 946 and applies a layer normalization to the result to generate encoder output representation 952. Transformer model 942 feeds encoder output representation 952 into multi-head attention layer 957 of decoder 954 as explained herein.

Masked multi-head attention layer 955 receives outputs of embedded subsequences 950 and computes representations for each of the output tokens of embedded subsequences 950 based on masked outputs of embedded subsequences 950. For example, masked multi-head attention layer 955 computes representations for each of the output tokens of embedded subsequences 950 based on previous output tokens while masking future output tokens. Masked multi-head attention layer 955 therefore computes representations using tokens that come before the token the masked multi-head attention layer 955 is trying to predict.

Transformer model 942 feeds the representation generated by masked multi-head attention layer 955 and residual connections from the outputs of embedded subsequences 950 into add & norm layer 956. Add & norm layer 956 sums the representation generated by masked multi-head attention layer 955 and the residual connections from outputs of embedded subsequences 950 and applies a layer normalization to the result.

Transformer model 942 feeds the normalized output of add & norm layer 956 into multi-head attention layer 957. Multi-head attention layer 957 receives the normalized output of add & norm layer 956 as well as encoder output representation 952 from encoder 944 and generates a representation based on both.

Transformer model 942 feeds the representation generated by multi-head attention layer 957 and residual connections from the output of add & norm layer 956 into add & norm layer 958. Add & norm layer 958 sums the representation generated by multi-head attention layer 957 and the residual connections from the output of add & norm layer 956 and applies a layer normalization to the result.

Transformer model 942 feeds the normalized output of add & norm layer 958 into feed-forward layer 959. Feed-forward layer 959 is a feed-forward network that receives the normalized output, feeds it through the layers of feed-forward layer 959, and then feeds the output of feed-forward layer 959 into add & norm layer 969. Feed-forward layer 959 processes the information received from add & norm layer 958 and can update the layers of feed-forward layer 959 based on the information (e.g., during training) and/or generate an output based on the hidden layers processing the information (e.g., during evaluation and/or inference). For example, during training, transformer model 942 updates the weights of the layers of feed-forward layer 959 based on the inputs and the loss of the transformer system. As an alternative example, during evaluation and/or inference, the weights of the layers of feed-forward layer 959 are used to determine the output of feed-forward layer 959.

Transformer model 942 feeds the output of feed-forward layer 959 into add & norm layer 960 as well as residual connections from the output of add & norm layer 958. Add & norm layer 960 sums the output of feed-forward layer 959 with the residual connections from add & norm layer 958 and applies a layer normalization to the result to generate an output.

Transformer model 942 generates output probabilities 962 from the output of add & norm layer 960. For example, transformer model 942 applies a linear transformation and a SoftMax function to the output of add & norm layer 960 to generate a normalized vector of output probabilities 962.

In some embodiments, such as during training, transformer model 942 determines a loss based on output probabilities 962. For example, transformer model 942 uses deep quantile regression for training. In such an example, output probabilities 962 includes a mean prediction probability and estimations for the upper and lower bounds of the range of prediction such that output probabilities 962 include an uncertainty range. In one embodiment, the loss function of transformer model 942 using deep quantile regression is represented by the following equation:

$$L ( {ξ}_{i} \vert α ) = \{ \begin{matrix}{αξ}_{i} if {ξ}_{i} \geq 0 , \\ ( α - 1 ) {ξ}_{i} if {ξ}_{i} < 0\end{matrix} ,$$

where a is the required quantile (a value between 0 and 1 representing the desired quantile) and § i=yᵢ−f(x;), where f(x;) is the mean predicted by output probabilities 962, yᵢ are the outputs of embedded subsequences 950 and xᵢ are the inputs of embedded subsequences 950. The loss over the entirety of a dataset of embedded subsequences 950 where embedded subsequences 950 has a length of N can be represented by the following equation:

$$ℒ ( y , f \vert α ) = \frac{1}{N} {\sum }_{i = 1}^{N} ℒ ( {y}_{i} - f ( {x}_{i} ) \vert α ) .$$

In such embodiments, output probabilities 962 includes three values: a mean prediction, a lower bound quantile, and an upper bound quantile. In some embodiments, transformer model 942 uses upper confidence bound or Thompson sampling. For example, transformer model 942 can determine model output 964 based on the mean prediction, the lower bound quantile, and the upper bound quantile based on upper confidence bound and/or Thompson sampling.

The transformer model 942 is trained to optimize the model parameters using any loss function such as cross-entropy loss. Similarly, the add & norm layers can normalize their respective inputs using any normalization technique. For example, the add & norm layers of transformer model 942 normalize the weights according to the following equation: Wi=C, where c is a positive scalar used for global normalization. In some embodiments, the scalar c is predetermined.

Language models, including large language models and other generative models, can be implemented using transformer models. A generative model can be constructed using a neural network-based machine learning model architecture. In some implementations, the neural network-based architecture includes one or more input layers that receive task descriptions (or prompts), generate one or more embeddings based on the task descriptions, and pass the one or more embeddings to one or more other layers of the neural network. In other implementations, the one or more embeddings are generated based on the task description by a pre-processor, the embeddings are input to the generative language model, and the generative language model outputs digital content, e.g., natural language text or a combination of natural language text and non-text output, based on the embeddings.

In some examples, the neural network-based machine learning model architecture of a generative model includes or is based on one or more generative transformer models, one or more generative pre-trained transformer (GPT) models, one or more bidirectional encoder representations from transformers (BERT) models, one or more large language models (LLMs), one or more XLNet models, and/or one or more other natural language processing (NL) models that significantly advance the state-of-the-art in various linguistic tasks such as machine translation, sentiment analysis, question answering and sentence similarity. In some examples, the neural network-based machine learning model architecture includes or is based on one or more predictive content neural models that can receive digital content input and generate one or more outputs based on processing the digital content with one or more neural network models. Examples of predictive neural models include, but are not limited to, Generative Pre-Trained Transformers (GPT), BERT, and/or Recurrent Neural Networks (RNNs). In some examples, one or more types of neural network-based machine learning model architecture includes or is based on one or more multimodal neural networks capable of outputting different modalities (e.g., text, image, sound, etc.) separately and/or in combination based on digital content input. Accordingly, in some examples, a multimodal neural network is capable of outputting digital content that includes a combination of two or more of text, images, video or sound.

A generative language model can be trained on a large dataset of natural language text. For example, training samples of natural language text extracted from publicly available data sources can be used to train a generative language model. The size and composition of the dataset used to train the generative language model can vary according to the requirements of a particular design or implementation. In some implementations, the dataset used to train the generative language model includes hundreds of thousands to millions or more different natural language text training samples. In some implementations, reinforcement learning is used to further improve the output of the generative language model. In reinforcement learning, ground-truth examples of desired model output are paired with respective prompts, and these prompt-output pairs are used to train or fine tune the generative language model.

Supervised learning is a method of training (or fine-tuning) a machine learning model given input-output pairs, where the output of the input-output pair is known (e.g., an expected output, a labeled output, a ground truth). Other training methods including semi-supervised learning or federated learning can be used to train a machine learning model or to fine-tune a pretrained machine learning model.

To train or fine tune a language model, a prompt is provided as input to the machine learning model. The prompt can include natural language instructions, queries, examples, etc. The machine learning model generates output by applying the weights and nodes of the machine learning model to the prompt. Error can be determined by comparing the model output to a reference or expected output. For example, the similarity between the model output and the expected output is evaluated using a similarity metric or model performance metric. The error is used to adjust the value of weights in a weight matrix included in the machine learning model and/or the number of layers and/or arrangement of layers included in the machine learning model.

A machine learning model can be trained using a backpropagation algorithm. The backpropagation algorithm operates by propagating the error through each of the algorithmic weights of the machine learning model such that the algorithmic weights are adjusted based on the amount of error. The error can be calculated at each iteration, batch, and/or epoch. The error is computed using a loss function. An example loss function includes the cross-entropy error function. After a number of training iterations, the machine learning model iteratively converges, e.g., adjusts weight values over time until the model output achieves an acceptable level of accuracy or reliability (e.g., accuracy satisfies a defined tolerance or confidence level). The values of the weights of the trained model (e.g., after convergence) are stored such that the machine learning model can be deployed during inference time.

The machine learning model 942 can be configured and implemented as a network service. For example, the machine learning model 932 can be configured using a machine learning library and an application programming interface (API), e.g., via an API call such as ML_library.model (p1, p2, . . . pn), where p indicates a parameter or argument of the call, such as a model hyperparameter or an input feature set identifier. Once configured, the machine learning model 942 and/or its output can be hosted on one or more servers and/or data storage devices for accessibility to one or more requesting processes, systems, devices, frameworks, or services.

The examples shown in FIG. 9 and the accompanying description above are provided for illustration purposes. This disclosure is not limited to the described examples. Additional or alternative details and implementations are described herein.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100 described in FIG. 1 or the computing system 600 described in FIG. 6, can carry out the above-described computer-implemented methods in response to its processor executing a computer program (e.g., a sequence of instructions) contained in a memory or other non-transitory machine-readable storage medium (e.g., a non-transitory computer readable medium). Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities.

According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Illustrative examples of the technologies disclosed herein are provided below. An embodiment of the technologies may include any of the examples described herein, or any combination of any of the examples described herein, or any combination of any portions of the examples described herein.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform. According to the techniques described herein, personal data may be removed from any training dataset that is used to train AI models.

The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

In some aspects, the techniques described herein relate to a method including: receiving, via a user interface, a query associated with a digital content item, wherein the digital content item includes a criterion; determining a task responsive to the query; generating a first sub-task and a second sub-task associated with the task, wherein the first sub-task includes a classification task related to a user and the criterion, and wherein the second sub-task includes a content generation task related to the classification task; performing the first sub-task by determining, by a first machine learning model, a classification for a user with respect to the criterion; performing the second sub-task by determining, by a second machine learning model, a natural language text explanation for the classification determined by the first machine learning model; and causing the classification and the natural language text explanation to be presented via the user interface.

In some aspects, the techniques described herein relate to a method, wherein: the first machine learning model is trained to perform the classification task using a first set of pseudo labels generated by a teacher model, and the second machine learning model is trained to perform the content generation task using a second set of pseudo labels generated by the teacher model.

In some aspects, the techniques described herein relate to a method, wherein the first set of pseudo labels are domain-specific classification pseudo labels generated using domain-neutral seed data generated by a seed data generator.

In some aspects, the techniques described herein relate to a method, wherein the second set of pseudo labels are domain-specific content pseudo labels and the domain-specific classification pseudo labels are generated using domain-neutral seed data generated by the seed data generator.

In some aspects, the techniques described herein relate to a method, wherein an input to the first machine learning model includes the digital content item and user information.

In some aspects, the techniques described herein relate to a method, wherein an input to the second machine learning model includes the digital content item, user information, and the classification.

In some aspects, the techniques described herein relate to a method, further including: receiving, via the user interface, a second query associated with a second digital content item, wherein the second digital content item includes a second criterion; determining a second task responsive to the second query; generating a plurality of sub-tasks associated with the second task; and performing each of the sub-tasks of the plurality of sub-tasks using respective machine learning models.

In some aspects, the techniques described herein relate to a system including: at least one processor; and at least one memory device coupled to the at least one processor, wherein the at least one memory device includes instructions that, when executed by the at least one processor, cause the at least one processor to perform at least one operation including: receiving, via a user interface, a query associated with a digital content item, wherein the digital content item includes a criterion; determining a task responsive to the query; generating a first sub-task and a second sub-task associated with the task, wherein the first sub-task includes a classification task related to a user and the criterion, and wherein the second sub-task includes a content generation task related to the classification task; performing the first sub-task by determining, by a first machine learning model, a classification for a user with respect to the criterion; performing the second sub-task by determining, by a second machine learning model, a natural language text explanation for the classification determined by the first machine learning model; and causing the classification and the natural language text explanation to be presented via the user interface.

In some aspects, the techniques described herein relate to a system, wherein the first machine learning model is trained to perform the classification task using a first set of pseudo labels generated by a teacher model, and the second machine learning model is trained to perform the content generation task using a second set of pseudo labels generated by the teacher model.

In some aspects, the techniques described herein relate to a system, wherein the first set of pseudo labels are domain-specific classification pseudo labels generated using domain-neutral seed data generated by a seed data generator.

In some aspects, the techniques described herein relate to a system, wherein the second set of pseudo labels are domain-specific content pseudo labels and the domain-specific classification pseudo labels are generated using domain-neutral seed data generated by the seed data generator.

In some aspects, the techniques described herein relate to a system, wherein an input to the first machine learning model includes the digital content item and user information.

In some aspects, the techniques described herein relate to a system, wherein an input to the second machine learning model includes the digital content item, user information, and the classification.

In some aspects, the techniques described herein relate to a system, further including instructions that, when executed by the at least one processor, cause the at least one processor to perform at least one operation including: receiving, via the user interface, a second query associated with a second digital content item, wherein the second digital content item includes a second criterion; determining a second task responsive to the second query; generating a plurality of sub-tasks associated with the second task; and performing each of the sub-tasks of the plurality of sub-tasks using respective machine learning models.

In some aspects, the techniques described herein relate to a non-transitory machine-readable storage medium including instructions that, when executed by at least one processor, cause the at least one processor to perform at least one operation including: receiving, via a user interface, a query associated with a digital content item, wherein the digital content item includes a criterion; determining a task responsive to the query; generating a first sub-task and a second sub-task associated with the task, wherein the first sub-task includes a classification task related to a user and the criterion, and wherein the second sub-task includes a content generation task related to the classification task; performing the first sub-task by determining, by a first machine learning model, a classification for a user with respect to the criterion; performing the second sub-task by determining, by a second machine learning model, a natural language text explanation for the classification determined by the first machine learning model; and causing the classification and the natural language text explanation to be presented via the user interface.

In some aspects, the techniques described herein relate to a non-transitory machine-readable storage medium, wherein: the first machine learning model is trained to perform the classification task using a first set of pseudo labels generated by a teacher model, and the second machine learning model is trained to perform the content generation task using a second set of pseudo labels generated by the teacher model.

In some aspects, the techniques described herein relate to a non-transitory machine-readable storage medium, wherein the first set of pseudo labels are domain-specific classification pseudo labels generated using domain-neutral seed data generated by a seed data generator.

In some aspects, the techniques described herein relate to a non-transitory machine-readable storage medium, wherein the second set of pseudo labels are domain-specific content pseudo labels and the domain-specific classification pseudo labels are generated using domain-neutral seed data generated by the seed data generator.

In some aspects, the techniques described herein relate to a non-transitory machine-readable storage medium, wherein an input to the first machine learning model includes the digital content item and user information.

In some aspects, the techniques described herein relate to a non-transitory machine-readable storage medium, wherein an input to the second machine learning model includes the digital content item, user information, and the classification.

Clause 1. A method comprising: receiving, via a user interface, a query associated with a digital content item, wherein the digital content item comprises a criterion; determining a task responsive to the query; generating a first sub-task and a second sub-task associated with the task, wherein the first sub-task comprises a classification task related to a user and the criterion, and wherein the second sub-task comprises a content generation task related to the classification task; performing the first sub-task by determining, by a first machine learning model, a classification for a user with respect to the criterion; performing the second sub-task by determining, by a second machine learning model, a natural language text explanation for the classification determined by the first machine learning model; and causing the classification and the natural language text explanation to be presented via the user interface.

Clause 2. The method of clause 1, wherein: the first machine learning model is trained to perform the classification task using a first set of pseudo labels generated by a teacher model, and the second machine learning model is trained to perform the content generation task using a second set of pseudo labels generated by the teacher model.

Clause 3. The method of clause 2, wherein the first set of pseudo labels are domain-specific classification pseudo labels generated using domain-neutral seed data generated by a seed data generator.

Clause 4. The method of any clauses 1-3, wherein the second set of pseudo labels are domain-specific content pseudo labels and the domain-specific classification pseudo labels are generated using domain-neutral seed data generated by the seed data generator.

Clause 5. The method of any clauses 1-4, wherein an input to the first machine learning model comprises the digital content item and user information.

Clause 6. The method of any clauses 1-5, wherein an input to the second machine learning model comprises the digital content item, user information, and the classification.

Clause 7. The method any clauses 1-6, further comprising: receiving, via the user interface, a second query associated with a second digital content item, wherein the second digital content item comprises a second criterion; determining a second task responsive to the second query; generating a plurality of sub-tasks associated with the second task; and performing each of the sub-tasks of the plurality of sub-tasks using respective machine learning models.

Clause 8. A system comprising: at least one processor; and at least one memory device coupled to the at least one processor, wherein the at least one memory device comprises instructions that, when executed by the at least one processor, cause the at least one processor to perform at least one operation comprising: receiving, via a user interface, a query associated with a digital content item, wherein the digital content item comprises a criterion; determining a task responsive to the query; generating a first sub-task and a second sub-task associated with the task, wherein the first sub-task comprises a classification task related to a user and the criterion, and wherein the second sub-task comprises a content generation task related to the classification task; performing the first sub-task by determining, by a first machine learning model, a classification for a user with respect to the criterion; performing the second sub-task by determining, by a second machine learning model, a natural language text explanation for the classification determined by the first machine learning model; and causing the classification and the natural language text explanation to be presented via the user interface.

Clause 9. The system of clause 8, wherein the first machine learning model is trained to perform the classification task using a first set of pseudo labels generated by a teacher model, and the second machine learning model is trained to perform the content generation task using a second set of pseudo labels generated by the teacher model.

Clause 10. The system of clause 8 or clause 9, wherein the first set of pseudo labels are domain-specific classification pseudo labels generated using domain-neutral seed data generated by a seed data generator.

Clause 11. The system of any clauses 8-10, wherein the second set of pseudo labels are domain-specific content pseudo labels and the domain-specific classification pseudo labels are generated using domain-neutral seed data generated by the seed data generator.

Clause 12. The system of any clauses 8-11, wherein an input to the first machine learning model comprises the digital content item and user information.

Clause 13. The system of any clauses 8-12, wherein an input to the second machine learning model comprises the digital content item, user information, and the classification.

Clause 14. The system of any clauses 8-13, further comprising instructions that, when executed by the at least one processor, cause the at least one processor to perform at least one operation comprising: receiving, via the user interface, a second query associated with a second digital content item, wherein the second digital content item comprises a second criterion; determining a second task responsive to the second query; generating a plurality of sub-tasks associated with the second task; and performing each of the sub-tasks of the plurality of sub-tasks using respective machine learning models.

Clause 15. A non-transitory machine-readable storage medium comprising instructions that, when executed by at least one processor, cause the at least one processor to perform at least one operation comprising: receiving, via a user interface, a query associated with a digital content item, wherein the digital content item comprises a criterion; determining a task responsive to the query; generating a first sub-task and a second sub-task associated with the task, wherein the first sub-task comprises a classification task related to a user and the criterion, and wherein the second sub-task comprises a content generation task related to the classification task; performing the first sub-task by determining, by a first machine learning model, a classification for a user with respect to the criterion; performing the second sub-task by determining, by a second machine learning model, a natural language text explanation for the classification determined by the first machine learning model; and causing the classification and the natural language text explanation to be presented via the user interface.

Clause 16. The non-transitory machine-readable storage medium of clause 15, wherein: the first machine learning model is trained to perform the classification task using a first set of pseudo labels generated by a teacher model, and the second machine learning model is trained to perform the content generation task using a second set of pseudo labels generated by the teacher model.

Clause 17. The non-transitory machine-readable storage medium of clause 16 or clause 15, wherein the first set of pseudo labels are domain-specific classification pseudo labels generated using domain-neutral seed data generated by a seed data generator.

Clause 18. The non-transitory machine-readable storage medium of any clauses 15-17, wherein the second set of pseudo labels are domain-specific content pseudo labels and the domain-specific classification pseudo labels are generated using domain-neutral seed data generated by the seed data generator.

Clause 19. The non-transitory machine-readable storage medium of any clauses 15-18, wherein an input to the first machine learning model comprises the digital content item and user information.

Clause 20. The non-transitory machine-readable storage medium of any clauses 15-19, wherein an input to the second machine learning model comprises the digital content item, user information, and the classification.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

1. A method comprising:
receiving, via a user interface, a query associated with a digital content item, wherein the digital content item comprises a plurality of qualifications associated with a job posting;
determining a task responsive to the query;
generating a first sub-task and a second sub-task associated with the task, wherein the first sub-task comprises a classification task, and wherein the second sub-task comprises a content generation task;
performing the first sub-task by determining, by a first machine learning model, a classification for a user with respect to the plurality of qualifications associated with the job posting;
performing the second sub-task by determining, by a second machine learning model, a natural language text explanation for the classification determined by the first machine learning model;
performing by the first machine learning model or the second machine learning model, a total classification for the user with respect to an aggregate of the plurality of qualifications associated with the job posting; and
causing the total classification- and the natural language text explanation to be presented via the user interface.

2. The method of claim 1, wherein:
the first machine learning model is trained to perform the classification task using a first set of pseudo labels generated by a teacher model, and
the second machine learning model is trained to perform the content generation task using a second set of pseudo labels generated by the teacher model.

3. The method of claim 2, wherein the first set of pseudo labels are domain-specific classification pseudo labels generated using domain-neutral seed data generated by a seed data generator.

4. The method of claim 3, wherein the second set of pseudo labels are domain-specific content pseudo labels and the domain-specific classification pseudo labels are generated using domain-neutral seed data generated by the seed data generator.

5. The method of claim 1, wherein an input to the first machine learning model comprises the digital content item and user information.

6. The method of claim 1, wherein an input to the second machine learning model comprises the digital content item, user information, and the classification.

7. The method of claim 1, further comprising:
receiving, via the user interface, a second query associated with a second digital content item, wherein the second digital content item comprises a second criterion;
determining a second task responsive to the second query;
generating a plurality of sub-tasks associated with the second task; and
performing each of the sub-tasks of the plurality of sub-tasks using respective machine learning models.

8. A system comprising:
at least one processor; and
at least one memory device coupled to the at least one processor, wherein the at least one memory device comprises instructions that, when executed by the at least one processor, cause the at least one processor to perform at least one operation comprising:
receiving, via a user interface, a query associated with a digital content item, wherein the digital content item comprises a plurality of qualifications associated with a job posting;
determining a task responsive to the query;
generating a first sub-task and a second sub-task associated with the task, wherein the first sub-task comprises a classification task related to a user and the criterion, and wherein the second sub-task comprises a content generation task related to the classification task;
performing the first sub-task by determining, by a first machine learning model, a classification for a user with respect to the plurality of qualifications associated with the job posting the criterion;
performing the second sub-task by determining, by a second machine learning model, a natural language text explanation for the classification determined by the first machine learning model;
performing by the first machine learning model or the second machine learning model, a total classification for the user with respect to an aggregate of the plurality of qualifications associated with the job posting; and
causing the total classification and the natural language text explanation to be presented via the user interface.

9. The system of claim 8, wherein
the first machine learning model is trained to perform the classification task using a first set of pseudo labels generated by a teacher model, and
the second machine learning model is trained to perform the content generation task using a second set of pseudo labels generated by the teacher model.

10. The system of claim 9, wherein the first set of pseudo labels are domain-specific classification pseudo labels generated using domain-neutral seed data generated by a seed data generator.

11. The system of claim 10, wherein the second set of pseudo labels are domain-specific content pseudo labels and the domain-specific classification pseudo labels are generated using domain-neutral seed data generated by the seed data generator.

12. The system of claim 8, wherein an input to the first machine learning model comprises the digital content item and user information.

13. The system of claim 8, wherein an input to the second machine learning model comprises the digital content item, user information, and the classification.

14. The system of claim 8, further comprising instructions that, when executed by the at least one processor, cause the at least one processor to perform at least one operation comprising:
receiving, via the user interface, a second query associated with a second digital content item, wherein the second digital content item comprises a second criterion;
determining a second task responsive to the second query;
generating a plurality of sub-tasks associated with the second task; and
performing each of the sub-tasks of the plurality of sub-tasks using respective machine learning models.

15. A non-transitory machine-readable storage medium comprising instructions that, when executed by at least one processor, cause the at least one processor to perform at least one operation comprising:
receiving, via a user interface, a query associated with a digital content item, wherein the digital content item comprises a plurality of qualifications associated with a job posting a criterion;
determining a task responsive to the query;
generating a first sub-task and a second sub-task associated with the task, wherein the first sub-task comprises a classification task related to a user and the criterion, and wherein the second sub-task comprises a content generation task related to the classification task;
performing the first sub-task by determining, by a first machine learning model, a classification for a user with respect to the plurality of qualifications associated with the job posting the criterion;
performing the second sub-task by determining, by a second machine learning model, a natural language text explanation for the classification determined by the first machine learning model;
performing by the first machine learning model or the second machine learning model, a total classification for the user with respect to an aggregate of the plurality of qualifications associated with the job posting; and
causing the total classification and the natural language text explanation to be presented via the user interface.

16. The non-transitory machine-readable storage medium of claim 15, wherein:
the first machine learning model is trained to perform the classification task using a first set of pseudo labels generated by a teacher model, and
the second machine learning model is trained to perform the content generation task using a second set of pseudo labels generated by the teacher model.

17. The non-transitory machine-readable storage medium of claim 16, wherein the first set of pseudo labels are domain-specific classification pseudo labels generated using domain-neutral seed data generated by a seed data generator.

18. The non-transitory machine-readable storage medium of claim 17, wherein the second set of pseudo labels are domain-specific content pseudo labels and the domain-specific classification pseudo labels are generated using domain-neutral seed data generated by the seed data generator.

19. The non-transitory machine-readable storage medium of claim 15, wherein an input to the first machine learning model comprises the digital content item and user information.

20. The non-transitory machine-readable storage medium of claim 15, wherein an input to the second machine learning model comprises the digital content item, user information, and the classification.
